(19) United States
(12) Patent Application Publication
(10) Pub. No.: US 2025/0023677 A1
(43) Pub. Date: Jan. 16, 2025

(54) METHOD AND DEVICE IN NODES USED FOR WIRELESS COMMUNICATION

(71) Applicants: Lu WU, Shanghai (CN); Shulin SONG, Shanghai (CN); Xiaobo ZHANG, Shanghai (CN)

(72) Inventors: Lu WU, Shanghai (CN); Shulin SONG, Shanghai (CN); Xiaobo ZHANG, Shanghai (CN)

(73) Assignee: SHANGHAI LANGBO COMMUNICATION TECHNOLOGY COMPANY LIMITED, Shanghai (CN)

(21) Appl. No.: 18/766,689

(22) Filed: Jul. 9, 2024

(30) Foreign Application Priority Data
Jul. 13, 2023 (CN) 202310862096.1

(51) Int. Cl. H04L 5/00

(52) U.S. Cl. CPC H04L 5/0023; H04L 5/0053

(57) ABSTRACT

A first node receives a first information block set, the first information block set is used to configure multiple CORESETs, the multiple CORESETs are configured to N cells; determines a first CORESET from the multiple CORESETs, monitors a PDCCH in only a target CORESET group in the multiple CORESETs in a first time window, the first time window consists of multiple overlapping PDCCH monitoring occasions, the multiple overlapping PDCCH monitoring occasions respectively comprise time-domain resources occupied by PDCCH candidates in the multiple CORESETs; the target CORESET group comprises each CORESET having same QCL properties as the first CORESET among the multiple CORESETs; each of the N cells comprises at least one of two types of symbols in the first time window; a determination of the first CORESET depends on whether at least one of the N cells comprises a first-type symbol in the first time window.

### CROSS REFERENCE TO RELATED APPLICATIONS

This application claims the priority benefit of Chinese Patent Application No. 202310862096.1, filed on Jul. 13, 2023, the full disclosure of which is incorporated herein by reference.

### BACKGROUND

### Technical Field

The present application relates to transmission methods and devices in wireless communication systems, and in particular to a transmission scheme and device in a wireless communication system.

### Related Art

In existing NR (New Radio) systems, spectrum resources are statically divided into FDD (Frequency Division Duplexing) spectrum and TDD (Time Division Duplexing) spectrum. For the TDD spectrum, both the base station and User Equipment (UE) operate in half-duplex mode. This half-duplex mode avoids self-interference and can mitigate the impact of Cross Link interference, but also brings about a decrease in resource utilization and an increase in latency. For these problems, supporting flexible duplex mode on the TDD spectrum or FDD spectrum becomes a possible solution. The research work for duplex technology is approved at 3GPP RAN (Radio Access Network) 1 #103e meeting, in which SubBand non-overlapping Full Duplex (SBFD) was proposed, i.e., the base station is supported to simultaneously transmit and receive on two subbands at the same time. Communications in this mode is subject to severe interference, both self-interference and cross-link interference.

### SUMMARY

Inventors have found through researches that when multiple CORESETs (COntrol REsource SET) are configured to multiple cells, how to determine in which CORESETs in multiple overlapping PDCCH (Physical Downlink Control CHannel) monitoring occasions a PDCCH is monitored is a key issue.

To address the above problem, the present application provides a solution. It should be noted that in the description of the application, flexible duplex mode is only used as a typical application scenario or example; the present application can also be applied to other scenarios facing similar problems (including but not limited to SBFD, other flexible duplex or full duplex modes, variable link direction modes, traditional duplex modes, half duplex modes, energy-saving scenarios, non energy-saving scenarios, capacity enhancement systems, close range communication systems, unlicensed frequency-domain communications, IoT (Internet of Things), URLLC (Ultra Reliable Low Latency Communication) networks, Internet of Vehicles (IoV), etc.), where similar technical effects can be achieved. Additionally, adopting a unified design approach for different scenarios can also help reduce hardware complexity and cost. If no conflict is incurred, embodiments in any node in the present application and the characteristics of the embodiments are also applicable to any other node, and vice versa. And the embodiments in the present application and the characteristics in the embodiments can be arbitrarily combined if there is no conflict.

In one embodiment, interpretations of the terminology in the present application refer to definitions given in the 3GPP TS38 series.

In one embodiment, interpretations of the terminology in the present application refer to definitions given in the 3GPP TS37 series.

The present application provides a method in a first node for wireless communications, comprising:
receiving a first information block set, the first information block set being used to configure multiple CORESETs, the multiple CORESETs being configured to N cells, N being a positive integer greater than 1;
determining a first CORESET from the multiple CORESETs; and
monitoring a PDCCH in only a target CORESET group in the multiple CORESETs in a first time window, the first time window consisting of multiple overlapping PDCCH monitoring occasions, the multiple overlapping PDCCH monitoring occasions respectively comprising time-domain resources occupied by PDCCH candidates in the multiple CORESETs;
herein, the target CORESET group comprises each CORESET having same QCL properties as the first CORESET among the multiple CORESETs: each of the N cells comprises at least one of two types of symbols in the first time window: a determination of the first CORESET depends on whether at least one of the N cells comprises a first-type symbol in the first time window, and the first-type symbol is one of the two types of symbols.

In one embodiment, a problem to be solved in the present application comprises: when multiple CORESETs are configured to multiple cells, how to determine in which CORESETs among multiple overlapping PDCCH monitoring occasions a PDCCH is monitored.

In one embodiment, advantages of adopting the above method include: flexibly adjusting PDCCH monitoring in multiple overlapping PDCCH monitoring occasions.

In one embodiment, advantages of adopting the above method include: being suitable for different application scenarios/environment/modes, improving the flexibility of the system.

In one embodiment, advantages of adopting the above method include: supporting flexible duplex mode, improving uplink coverage, and increasing uplink transmission capacity.

According to one aspect of the present application, it is characterized in that when there exists a cell comprising the first-type symbol in the first time window among the N cells, a determination of the first CORESET depends on cell(s) comprising the first-type symbol in the first time window among the N cells.

In one embodiment, characteristics of the above method comprise: selecting an appropriate CORESET through the first-type symbol, and monitoring a PDCCH in the selected CORESET in a first time window.

According to one aspect of the present application, it is characterized in that when each of the N cells does not comprise the first-type symbol in the first time window; the first CORESET corresponds to a first CSS set, the first CSS set being a CSS set with lowest index in a cell with lowest index containing CSS sets, or the first CORESET corresponds to a first USS set, the first USS set being a USS set with lowest index in a cell with lowest index or the first USS set being a USS set with lowest index in a cell with lowest index containing USS sets.

In one embodiment, advantages of adopting the above method comprise: having good backward compatibility and simplifying the system design.

According to one aspect of the present application, it is characterized in that when there exists a cell comprising the first-type symbol in the first time window among the N cells, a first cell subgroup comprises cell(s) comprising the first-type symbol in the first time window among the N cells: the first CORESET corresponds to a second CSS set, the second CSS set being a CSS set in the first cell subgroup, or the first CORESET corresponds to a second USS set, the second USS set being a USS set in the first cell subgroup.

In one embodiment, advantages of the above method comprise: monitoring a PDCCH in a CSS set or a USS set of a cell comprising the first-type symbol in the first time window, which supports flexible duplex mode, thus improving uplink transmission capacity and enhancing the system stability:

According to one aspect of the present application, it is characterized in that when there exists a cell comprising the first-type symbol in the first time window among the N cells, the first CORESET corresponds to a first CSS set, the first CSS set being a CSS set with lowest index in a cell with lowest index containing CSS sets, or the first CORESET corresponds to a second USS set, the second USS set being a USS set in a first cell subgroup, and the first cell subgroup comprising cell(s) comprising the first-type symbol in the first time window among the N cells.

In one embodiment, characteristics of the above method comprise: monitoring a PDCCH in CSS sets of N cells, and monitoring a PDCCH in a USS set of a cell only comprising the first-type symbol in the first time window among the N cells.

According to one aspect of the present application, comprising:
determining a second CORESET;
herein, the second CORESET is one of the multiple CORESETs, and QCL properties of the second CORESET are different from QCL properties of the first CORESET: the target CORESET group also comprises each CORESET having same QCL properties as the second CORESET among the multiple CORESETs.

In one embodiment, advantages of the above method comprise: supporting the monitoring of multiple CORESETs with different QCL properties in multiple overlapping PDCCH monitoring occasions, thus improving the system flexibility and transmission reliability.

According to one aspect of the present application, it is characterized in that the two types of symbols are configured as DL by higher-layer parameter(s): uplink transmission is supported on one or more resource blocks (RBs) in only the first-type symbol of the two types of symbols, or the other type of symbol in the two types of symbols that is not the first-type symbol is only used for downlink transmission, and at least a part of first-type symbols in a cell comprising the first-type symbol is used for uplink transmission.

In one embodiment, one feature of the above method is in: being suitable for different application scenarios/environment/modes, ensuring transmission reliability and improving uplink transmission capacity.

The present application provides a method in a second node for wireless communications, comprising:
transmitting a first information block set, the first information block set being used to configure multiple CORESETs, the multiple CORESETs being configured to N cells, N being a positive integer greater than 1;
herein, a receiver of the first information block set determines a first CORESET from the multiple CORESETs, and monitors a PDCCH in only a target CORESET group in the multiple CORESETs in a first time window: the first time window consists of multiple overlapping PDCCH monitoring occasions, the multiple overlapping PDCCH monitoring occasions respectively comprise time-domain resources occupied by PDCCH candidates in the multiple CORESETs: the target CORESET group comprises each CORESET having same QCL properties as the first CORESET among the multiple CORESETs: each of the N cells comprises at least one of two types of symbols in the first time window: a determination of the first CORESET depends on whether at least one of the N cells comprises a first-type symbol in the first time window, and the first-type symbol is one of the two types of symbols.

According to one aspect of the present application, it is characterized in that when there exists a cell comprising the first-type symbol in the first time window among the N cells, a determination of the first CORESET depends on cell(s) comprising the first-type symbol in the first time window among the N cells.

According to one aspect of the present application, it is characterized in that when each of the N cells does not comprise the first-type symbol in the first time window, the first CORESET corresponds to a first CSS set, the first CSS set being a CSS set with lowest index in a cell with lowest index containing CSS sets, or the first CORESET corresponds to a first USS set, the first USS set being a USS set with lowest index in a cell with lowest index or the first USS set being a USS set with lowest index in a cell with lowest index containing USS sets.

According to one aspect of the present application, it is characterized in that when there exists a cell comprising the first-type symbol in the first time window among the N cells, a first cell subgroup comprises cell(s) comprising the first-type symbol in the first time window among the N cells: the first CORESET corresponds to a second CSS set, the second CSS set being a CSS set in the first cell subgroup, or the first CORESET corresponds to a second USS set, the second USS set being a USS set in the first cell subgroup.

According to one aspect of the present application, it is characterized in that when there exists a cell comprising the first-type symbol in the first time window among the N cells, the first CORESET corresponds to a first CSS set, the first CSS set being a CSS set with lowest index in a cell with lowest index containing CSS sets, or the first CORESET corresponds to a second USS set, the second USS set being a USS set in a first cell subgroup, and the first cell subgroup comprising cell(s) comprising the first-type symbol in the first time window among the N cells.

According to one aspect of the present application, it is characterized in that a receiver of the first information block set determines a second CORESET: the second CORESET is one of the multiple CORESETs, and QCL properties of the second CORESET are different from QCL properties of the first CORESET: the target CORESET group also comprises each CORESET having same QCL properties as the second CORESET among the multiple CORESETs.

According to one aspect of the present application, it is characterized in that the two types of symbols are configured as DL by higher-layer parameter(s): uplink transmission is supported on one or more resource blocks (RBs) in only the first-type symbol of the two types of symbols, or the other type of symbol in the two types of symbols that is not the first-type symbol is only used for downlink transmission, and at least a part of first-type symbols in a cell comprising the first-type symbol is used for uplink transmission.

The present application provides a first node for wireless communications, comprising:
a first receiver, receiving a first information block set, the first information block set being used to configure multiple CORESETs, the multiple CORESETs being configured to N cells, N being a positive integer greater than 1;
a first processor, determining a first CORESET from the multiple CORESETs; and
the first receiver, monitoring a PDCCH in only a target CORESET group in the multiple CORESETs in a first time window, the first time window consisting of multiple overlapping PDCCH monitoring occasions, the multiple overlapping PDCCH monitoring occasions respectively comprising time-domain resources occupied by PDCCH candidates in the multiple CORESETs;
herein, the target CORESET group comprises each CORESET having same QCL properties as the first CORESET among the multiple CORESETs: each of the N cells comprises at least one of two types of symbols in the first time window: a determination of the first CORESET depends on whether at least one of the N cells comprises a first-type symbol in the first time window, and the first-type symbol is one of the two types of symbols.

The present application provides a second node for wireless communications, comprising:
a second transmitter, transmitting a first information block set, the first information block set being used to configure multiple CORESETs, the multiple CORESETs being configured to N cells, N being a positive integer greater than 1;
herein, a receiver of the first information block set determines a first CORESET from the multiple CORESETs, and monitors a PDCCH in only a target CORESET group in the multiple CORESETs in a first time window: the first time window consists of multiple overlapping PDCCH monitoring occasions, the multiple overlapping PDCCH monitoring occasions respectively comprise time-domain resources occupied by PDCCH candidates in the multiple CORESETs: the target CORESET group comprises each CORESET having same QCL properties as the first CORESET among the multiple CORESETs: each of the N cells comprises at least one of two types of symbols in the first time window; a determination of the first CORESET depends on whether at least one of the N cells comprises a first-type symbol in the first time window, and the first-type symbol is one of the two types of symbols.

In one embodiment, the present application has the following advantages over conventional schemes:
determining an appropriate CORESET used for monitoring a PDCCH;
flexibly adjusting PDCCH monitoring in multiple overlapping PDCCH monitoring occasions;
being suitable for different application scenarios/environment/modes, improving the flexibility of the system;
supporting flexible duplex mode and improving uplink coverage;
improving the reliability of communication transmission;
guaranteeing the service quality of the communication system.

### BRIEF DESCRIPTION OF THE DRAWINGS

Other features, objects and advantages of the present application will become more apparent from the detailed description of non-restrictive embodiments taken in conjunction with the following drawings:

FIG. 1 illustrates a flowchart of a first information block set, a first CORESET and a target CORESET group according to one embodiment of the present application;

FIG. 2 illustrates a schematic diagram of a network architecture according to one embodiment of the present application:

FIG. 3 illustrates a schematic diagram of a radio protocol architecture of a user plane and a control plane according to one embodiment of the present application:

FIG. 4 illustrates a schematic diagram of a first communication device and a second communication device according to one embodiment of the present application:

FIG. 5 illustrates a flowchart of wireless transmission according to one embodiment of the present application:

FIG. 6 illustrates a schematic diagram of a determination of a first CORESET according to one embodiment of the present application;

FIG. 7 illustrates a schematic diagram of relations among a first CORESET, a first CSS set and a first USS set according to one embodiment of the present application:

FIG. 8 illustrates a schematic diagram of relations among a first CORESET, a second CSS set and a second USS set according to one embodiment of the present application:

FIG. 9 illustrates a schematic diagram of relations among a first CORESET, a first CSS set and a second USS set according to one embodiment of the present application;

FIG. 10 illustrates a schematic diagram of a second CORESET according to one embodiment of the present application:

FIG. 11 illustrates a schematic diagram of two types of symbols according to one embodiment of the present application;

FIG. 12 illustrates a structure block diagram of a processor in a first node according to one embodiment of the present application;

FIG. 13 illustrates a structure block diagram of a processor in a second node according to one embodiment of the present application.

### DESCRIPTION OF THE EMBODIMENTS

The technical scheme of the present application is described below in further details in conjunction with the drawings. It should be noted that the embodiments of the present application and the characteristics of the embodiments may be arbitrarily combined if no conflict is caused.

### Embodiment 1

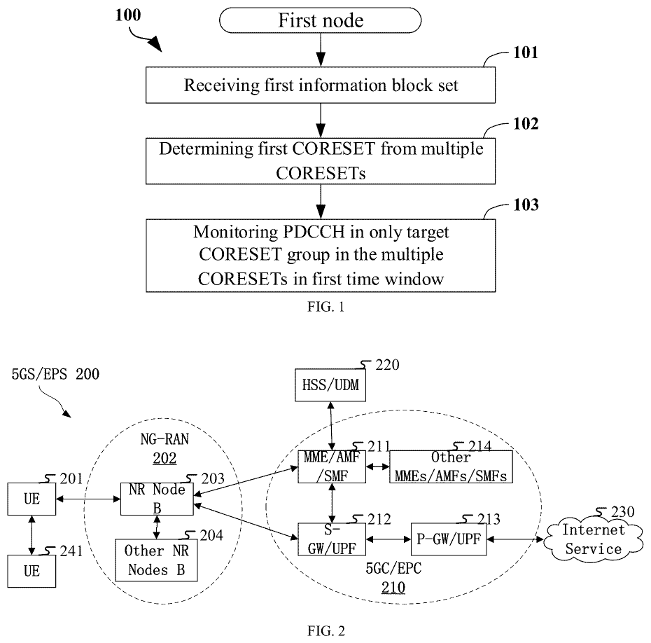

Embodiment 1 illustrates a flowchart of a first information block set, a first CORESET and a target CORESET group according to one embodiment of the present application, as shown in FIG. 1. In 100 illustrated by FIG. 1, each box represents a step.

In embodiment 1, the first node in the present application receives a first information block set in step 101, the first information block set is used to configure multiple CORESETs, the multiple CORESETs are configured to N cells, N being a positive integer greater than 1; determines a first CORESET from the multiple CORESETs in step 102; monitors a PDCCH in only a target CORESET group in the multiple CORESETs in a first time window in step 103, the first time window consists of multiple overlapping PDCCH monitoring occasions, the multiple overlapping PDCCH monitoring occasions respectively comprise time-domain resources occupied by PDCCH candidates in the multiple CORESETs; herein, the target CORESET group comprises each CORESET having same QCL properties as the first CORESET among the multiple CORESETs; each of the N cells comprises at least one of two types of symbols in the first time window; a determination of the first CORESET depends on whether at least one of the N cells comprises a first-type symbol in the first time window, and the first-type symbol is one of the two types of symbols.

In one embodiment, the first information block set is carried by a higher-layer signaling.

In one embodiment, the first information block set is carried by an RRC signaling.

In one embodiment, the first information block set comprises partial or all fields in an RRC IE.

In one embodiment, the first information block set comprises multiple RRC IEs.

In one embodiment, the first information block set comprises multiple RRC IE ControlResourceSets, and the multiple RRC IE ControlResourceSets are respectively used to configure multiple CORESETs of the N cells.

In one embodiment, the first information block set comprises partial or all fields in one or more than one RRC IE PDCCH-Config.

In one embodiment, the first information block set comprises a field whose name comprises controlResourceSetToAddModList in one or more than one RRC IE PDCCH-Config.

In one embodiment, the first information block set comprises a field whose name comprises controlResourceSetToAddModList and a field whose name comprises controlResourceSetToReleaseList in one or more than one RRC IE PDCCH-Config.

In one embodiment, the N cells comprise only one cell.

In one embodiment, the N cells comprise more than one cell.

In one embodiment, the N cells comprise only one cell, and the multiple CORESETs are configured to the only one cell.

In one embodiment, the N cells comprise more than one cell, any one of the multiple CORESETs is configured to one of the N cells, and any one of the N cells is configured with at least one of the multiple CORESETs.

In one embodiment, a CORESET (Control Resource Set) comprises multiple REs (Resource Elements).

Typically, one RE occupies one subcarrier in frequency domain and one symbol in time domain.

In one embodiment, the symbol is a single carrier symbol.

In one embodiment, the symbol is a multicarrier symbol.

In one embodiment, the multicarrier symbol is an Orthogonal Frequency Division Multiplexing (OFDM) symbol.

In one embodiment, the symbol is obtained after an output of transform precoding is through OFDM symbol generation.

In one embodiment, the symbol is a Single Carrier-Frequency Division Multiple Access (SC-FDMA) symbol.

In one embodiment, the symbol is a Discrete Fourier Transform Spread OFDM (DFT-S-OFDM) symbol.

In one embodiment, the multicarrier symbol is a Filter Bank Multicarrier (FBMC) symbol.

In one embodiment, the multicarrier symbol comprises a Cyclic Prefix (CP).

In one embodiment, a CORESET (Control Resource Set) comprises at least one CCE (Control Channel Element).

In one embodiment, a CCE comprises 9 Resource Element Groups (REGs), and an REG comprises 4 REs.

In one embodiment, an CCE comprises 6 REGs, and an REG comprises 12 REs.

In one embodiment, a CORESET is configured by an RRC IE (Information Element) ControlResourceSet.

In one embodiment, for the specific definition of CORESET, refer to chapter 10 in 3GPP TS 38.213.

In one embodiment, for the specific meaning of RRC IE ControlResourceSet, refer to chapter 6.3.2 in 3GPP TS 38.331.

In one embodiment, one CORESET corresponds to at least one SS (Search Space) set.

In one embodiment, any of the multiple CORESETs corresponds to one or more SS sets.

In one embodiment, any of the multiple CORESETs corresponds to only one SS set.

In one embodiment, an SS set corresponding to a CORESET is either a USS set or a CSS set.

In one embodiment, CSS refers to: Common Search Space (CSS).

In one embodiment, USS refers to: UE-specific Search Space.

In one embodiment, a PDCCH (Physical Downlink Control Channel) candidate in a CORESET belongs to the CORESET in frequency domain.

In one embodiment, a PDCCH candidate in a CORESET is a PDCCH candidate in an SS set corresponding to the CORESET.

In one embodiment, a PDCCH candidate in a CORESET consists of at least one CCE in the CORESET.

In one embodiment, any PDCCH candidate in an SS set corresponding to a CORESET consists of at least one CCE of the CORESET.

In one embodiment, a PDCCH candidate in an SS set corresponding to a CORESET belongs to the CORESET.

In one embodiment, the meaning of the phrase that “an SS set correspond to a CORESET” comprises: an SS set corresponding to a CORESET is associated with the CORESET.

In one embodiment, the meaning of “an SS set being with a CORESET” comprises: configuration information of the SS set comprises an index of the CORESET.

In one embodiment, the meaning of the phrase that “an SS set correspond to a CORESET” comprises: a CORESET is used to determine time-frequency resources occupied by an SS set corresponding to the CORESET in a PDCCH monitoring occasion.

In one embodiment, the meaning of the phrase of “an SS set corresponding to a CORESET” comprises: a CORESET comprises time-frequency resources occupied by an SS set corresponding to the CORESET in a PDCCH monitoring occasion.

In one embodiment, the meaning of the phrase of “an SS set corresponding to a CORESET” comprises: an RE occupied by a CORESET comprises an RE occupied by an SS set corresponding to the CORESET in a PDCCH monitoring occasion.

In one embodiment, the meaning of the phrase of “an SS set corresponding to a CORESET” comprises: RB(s) occupied by a CORESET in frequency domain comprises (comprise) RB(s) occupied by an SS set corresponding to a CORESET in frequency domain.

In one embodiment, the meaning of the phrase of “an SS set corresponding to a CORESET” comprises: frequency-domain resources occupied by a CORESET comprise frequency-domain resources occupied by an SS set corresponding to the CORESET.

In one embodiment, the meaning of the phrase of “an SS set corresponding to a CORESET” comprises: symbol(s) occupied by a CORESET is (are) used to determine symbol(s) occupied by an SS set corresponding to the CORESET in a PDCCH monitoring occasion.

In one embodiment, the meaning of the phrase of “an SS set corresponding to a CORESET” comprises: symbol(s) occupied by a CORESET comprises (comprise) symbol(s) occupied by an SS set corresponding to the CORESET in a PDCCH monitoring occasion.

In one embodiment, symbol(s) occupied by a CORESET in a PDCCH monitoring occasion belongs (belong) to symbol(s) occupied by the CORESET.

In one embodiment, symbol(s) occupied by a CORESET in a PDCCH monitoring occasion comprises (comprise) symbol(s) occupied by the CORESET.

In one embodiment, the meaning of the phrase of “an SS set corresponding to a CORESET” comprises: configuration information of an SS set corresponding to a CORESET comprises an index of the CORESET.

In one embodiment, the meaning of the phrase of “an SS set corresponding to a CORESET” comprises: an SS set corresponding to a CORESET is an SS set configured with an index of the CORESET.

In one embodiment, a PDCCH monitoring occasion comprises a time period.

In one embodiment, a PDCCH monitoring occasion comprises one or multiple symbols.

In one embodiment, a PDCCH monitoring occasion comprises a slot.

In one embodiment, a PDCCH monitoring occasion comprises a sub-slot.

In one embodiment, a PDCCH monitoring occasion comprises a subframe.

In one embodiment, the first time window comprises two overlapping PDCCH monitoring occasions.

In one embodiment, the first time window comprises more than two overlapping PDCCH monitoring occasions.

In one embodiment, the first time window comprises multiple overlapping PDCCH monitoring occasions.

In one embodiment, the first time window comprises a time period.

In one embodiment, the first time window comprises one or multiple symbols.

In one embodiment, the first time window comprises a slot.

In one embodiment, the first time window comprises a sub-slot.

In one embodiment, the first time window comprises a subframe.

In one embodiment, the cell in the present application comprises a serving cell.

In one embodiment, the cell in the present application comprises a physical cell.

In one embodiment, the cell in the present application comprises a CC (Component Carrier).

In one embodiment, the cell in the present application comprises a PCell (Primary Cell).

In one embodiment, the cell in the present application comprises an SCell (Secondary Cell).

In one embodiment, the cell in the present application comprises an SpCell (Special Cell).

In one embodiment, the cell in the present application is a serving cell of the first node.

In one embodiment, the cell in the present application is respectively allocated SCellIndex or ServCellIndex.

In one embodiment, the N cell comprises multiple cells.

In one embodiment, the N cells only comprises multiple serving cells.

In one embodiment, cells comprised in the N cells belongs to a same cell group.

In one embodiment, cells comprised in the N cells all belong to an MCG (Master Cell Group) or an SCG (Secondary Cell Group).

In one embodiment, cells comprised in the N cells belong to a same PUCCH (Physical Uplink Control Channel) group.

In one embodiment, a PUCCH group comprises a group of cells, a PUCCH signaling of the group of cells is associated with a PUCCH of an SpCell, or a PUCCH signaling of the group of cells is associated with a PUCCH of a PUCCH SCell; the PUCCH SCell is an SCell configured with a PUCCH.

In one embodiment, a PUCCH group comprises a group of cells, and a PUCCH signaling of the group of cells is associated with a PUCCH of a same cell.

In one embodiment, cells comprised in the N cells have a same numerology.

In one embodiment, cells comprised in the N cells have a same Subcarrier spacing configuration.

In one embodiment, there exist two cells in the N cells having different Subcarrier spacing configurations.

In one embodiment, active BWPs configured in cells comprised in the N cells comprise a same numerology.

In one embodiment, Active BWPs configured in cells comprised in the N cells have a same Subcarrier spacing configuration.

In one embodiment, there exist Active BWPs configured in two of the N cells having different Subcarrier spacing configurations.

In one embodiment, the meaning of “the multiple overlapping PDCCH monitoring occasions respectively comprising time-domain resources occupied by PDCCH candidates in the multiple CORESETs” comprises: the multiple overlapping PDCCH monitoring occasions are used to monitor PDCCH candidates among the multiple CORESETs.

In one embodiment, the meaning of “the multiple overlapping PDCCH monitoring occasions respectively comprising time-domain resources occupied by PDCCH candidates in the multiple CORESETs” comprises: PDCCH candidates belonging to the first time window among the multiple CORESETs respectively belong to the multiple overlapping PDCCH monitoring occasions in time domain.

In one embodiment, the meaning of “the multiple overlapping PDCCH monitoring occasions respectively comprising time-domain resources occupied by PDCCH candidates in the multiple CORESETs” comprises: the multiple overlapping PDCCH monitoring occasions respectively comprise time-domain resources occupied by PDCCH candidates in the first time window in the multiple CORESETs.

In one embodiment, the multiple CORESETs are two CORESETs.

In one embodiment, the multiple CORESETs are more than two CORESETs.

In one embodiment, the meaning of “the multiple overlapping PDCCH monitoring occasions respectively comprising time-domain resources occupied by PDCCH candidates in the multiple CORESETs” comprises: the first node respectively monitors PDCCH candidates in the multiple CORESETs in the multiple overlapping PDCCH monitoring occasions.

In one embodiment, the target CORESET group comprises partial or all CORESETs in the multiple CORESETs.

In one embodiment, the target CORESET group comprises partial CORESETs in the multiple CORESETs.

In one embodiment, the target CORESET group comprises the multiple CORESETs.

In one embodiment, the multiple overlapping PDCCH monitoring occasions are overlapping in pairs.

In one embodiment, any two PDCCH monitoring occasions in the multiple overlapping PDCCH monitoring occasions are overlapping.

In one embodiment, the multiple overlapping PDCCH monitoring occasions are two overlapping PDCCH monitoring occasions.

In one embodiment, the multiple overlapping PDCCH monitoring occasions are more than two overlapping PDCCH monitoring occasions.

In one embodiment, the multiple overlapping PDCCH monitoring occasions are respectively monitoring occasions of the multiple CORESETs.

In one embodiment, the meaning of “the multiple overlapping PDCCH monitoring occasions respectively comprising time-domain resources occupied by PDCCH candidates in the multiple CORESETs” comprises: the multiple overlapping PDCCH monitoring occasions respectively correspond to the multiple CORESETs, and at least one PDCCH candidate in any of the multiple CORESETs belongs to one of the corresponding multiple overlapping PDCCH monitoring occasions in time domain.

In one embodiment, the meaning of “the multiple overlapping PDCCH monitoring occasions respectively comprising time-domain resources occupied by PDCCH candidates in the multiple CORESETs” comprises: the multiple overlapping PDCCH monitoring occasions respectively correspond to the multiple CORESETs, and at least one PDCCH candidate in any of the multiple CORESETs is monitored in a PDCCH monitoring occasion in the corresponding multiple overlapping PDCCH monitoring occasions.

In one embodiment, the target CORESET group only comprises each CORESET having same QCL properties as the first CORESET among multiple CORESETs.

In one embodiment, the target CORESET group comprises each CORESET having same or different QCL properties as the first CORESET among multiple CORESETs.

In one embodiment, the target CORESET group comprises each CORESET with same QCL properties as the first CORESET and each CORESET with different QCL properties as the first CORESET among multiple CORESETs.

In one embodiment, the target CORESET group comprises at least one CORESET having same QCL properties as the first CORESET among multiple CORESETs.

In one embodiment, the target CORESET group comprises at least one CORESET having same or different QCL properties as the first CORESET among multiple CORESETs.

In one embodiment, the target CORESET group comprises at least one CORESET with same QCL properties as the first CORESET and at least one CORESET with different QCL properties as the first CORESET among multiple CORESETs.

In one embodiment, QCL properties of a CORESET depends on a TCI state applied to the CORESET.

In one embodiment, QCL properties of a CORESET depends on an RS (Reference Signal) resource indicated by a TCI state applied to the CORESET.

In one embodiment, QCL properties of a CORESET depends on QCL properties of an RS resource indicated by a TCI state applied to a CORESET.

In one embodiment, QCL properties of a CORESET are the same as QCL properties of an RS resource indicated by a TCI state applied to a CORESET.

In one embodiment, the QCL properties comprise QCL parameters.

In one embodiment, RS resources indicated by a TCI state is either an SS/PBCH block resource or a CSI-RS resource.

In one embodiment, for the purpose of determining the CORESET, an SS/PBCH block is considered to have different QCL ‘typeD’ properties than a CSI-RS.

In one embodiment, in a determination of the second CORESET, an SS/PBCH block is considered to have different QCL properties from a CSI-RS.

In one embodiment, in a determination of at least one CORESET in the target CORESET group, an SS/PBCH block is considered to have different QCL properties from a CSI-RS.

In one embodiment, the QCL properties are ‘typeD’ properties.

In one embodiment, the QCL properties are one of ‘typeA’ properties, ‘typeB’ properties, ‘typeC’ properties, or ‘typeD’ properties.

In one embodiment, ‘typeA’ properties comprise Doppler shift, Doppler spread, average delay, and delay spread.

In one embodiment, ‘typeB’ properties comprise Doppler shift and Doppler spread.

In one embodiment, ‘typeC’ properties comprise Doppler shift and average delay:

In one embodiment, ‘typeD’ properties comprise Spatial Rx parameters.

In one embodiment, for specific meanings of ‘typeA’, ‘typeB’, ‘typeC’, and ‘typeD’, refer to chapter 5.1.5 in 3GPP TS38.214.

In one embodiment, the target CORESET group comprises the first CORESET and the second CORESET.

In one embodiment, the target CORESET group at least comprises the first CORESET and the second CORESET.

In one embodiment, the target CORESET group only comprises the first CORESET and the second CORESET.

In one embodiment, the target CORESET group comprises the first CORESET and a second CORESET, as well as at least one CORESET other than the first CORESET and a second CORESET among the multiple CORESETs.

In one embodiment, the target CORESET group comprises at least one CORESET with same QCL properties as “one of the first CORESET and second CORESET”.

In one embodiment, a TCI state is applied to a CORESET.

In one embodiment, the meaning of “a TCI state being applied to a CORESET” comprises: an RS (Reference Signal) resource indicated by the TCI state is used to determine QCL properties of the CORESET.

In one embodiment, the meaning of “a TCI state being applied to a CORESET” comprises: QCL properties of an RS resource indicated by the TCI state are the same as QCL properties of the CORESET.

In one embodiment, “QCL properties of an RS resource indicated by the TCI state being the same as QCL properties of the CORESET” comprises: the first node assumes that QCL properties of an RS resource indicated by the TCI state are the same as QCL properties of the CORESET.

In one embodiment, the meaning of “a TCI state being applied to a CORESET” comprises: the TCI state is used to indicate quasi co-located information of a DMRS (Demodulation Reference Signals) antenna port for a PDCCH reception in the CORESET.

In one embodiment, the meaning of “a TCI state being applied to a CORESET” comprises: the TCI state is used to indicate quasi co-located parameters of a DMRS antenna port for a PDCCH reception in the CORESET.

In one embodiment, the meaning of “a TCI state being applied to a CORESET” comprises: the TCI state indicates a quasi co-location relationship between at least one reference signal resource and a DMRS antenna port for a PDCCH reception in the CORESET.

In one embodiment, the meaning of “a TCI state being applied to a CORESET” comprises: a DMRS antenna port for a PDCCH reception in the CORESET is quasi co-located with at least one reference signal resource indicated by the TCI state.

In one embodiment, the two types of symbols are configured by higher-layer parameters as DL.

In one embodiment, the two types of symbols are configured as DL (Down Link) or Flexible (Flexible) by higher-layer parameters.

In one embodiment, each of the N cells comprises a first-type symbol.

In one embodiment, each of the N cells comprises a first-type symbol, and the first-type symbols in the N cells are indicated separately.

In one embodiment, each of the N cells comprises a first-type symbol, and positions of the first-type symbols in the N cells are indicated separately.

In one embodiment, each of the N cells comprises a first-type symbol, and indexes of the first-type symbols in the N cells are indicated separately.

In one embodiment, each of the N cells comprises a first-type symbol, and the first-type symbols in the N cells are indicated by a same signaling.

In one embodiment, each of the N cells comprises a first-type symbol, and positions of the first-type symbols in the N cells are the same.

In one embodiment, each of the N cells comprises a first-type symbol, and indexes of the first-type symbols in the N cells are the same.

In one embodiment, only part of the N cells comprises a first-type symbol.

In one embodiment, a determination of the first CORESET depends on whether there exists one of the N cells comprising the first-type symbol in the first time window.

In one embodiment, a determination of the first CORESET depends on whether each of the N cells comprises the first-type symbol in the first time window.

In one embodiment, when there exists more than one cell in the N cells comprising the first-type symbol in the first time window, a determination of the first CORESET depends on a cell comprising the first-type symbol in the first time window among the N cells.

In one embodiment, when there exists one cell in the N cells comprising only the first-type symbol in the two types of symbols in the first time window, a determination of the first CORESET depends on a cell comprising the first-type symbol in the first time window among the N cells.

In one embodiment, when there exists more than one cell in the N cells comprising only the first-type symbol in the two types of symbols in the first time window, a determination of the first CORESET depends on a cell comprising the first-type symbol in the first time window among the N cells.

In one embodiment, when partial symbols comprised in one of the N cells in a first time window is the first-type symbol, a determination of the first CORESET depends on a cell comprising the first-type symbol in the first time window among the N cells.

In one embodiment, when partial symbols comprised in more than one of the N cells in a first time window is the first-type symbol, a determination of the first CORESET depends on a cell comprising the first-type symbol in the first time window among the N cells.

In one embodiment, when each symbol comprised in more than one of the N cells in a first time window is the first-type symbol, a determination of the first CORESET depends on a cell comprising the first-type symbol in the first time window among the N cells.

In one embodiment, when each symbol comprised in one of the N cells in a first time window is the first-type symbol, a determination of the first CORESET depends on a cell comprising the first-type symbol in the first time window among the N cells.

In one embodiment, when there exists one cell in the N cells comprising the first-type symbol and the other type of symbol in the two types of symbols in the first time window, a determination of the first CORESET depends on a cell comprising the first-type symbol in the first time window among the N cells.

In one embodiment, when there exists more than one cell in the N cells comprising the first-type symbol and the other type of symbol in the two types of symbols in the first time window, a determination of the first CORESET depends on a cell comprising the first-type symbol in the first time window among the N cells.

### Embodiment 2

Embodiment 2 illustrates a schematic diagram of a network architecture according to one embodiment of the present application, as shown in FIG. 2.

FIG. 2 is a diagram illustrating a network architecture 200 of Long-Term Evolution (LTE), Long-Term Evolution Advanced (LTE-A) and future 5G systems. The LTE, LTE-A and future 5G systems network architecture 200 may be called an Evolved Packet System (EPS) 200. The 5G NR or LTE network architecture 200 may be called a 5G System (5GS)/Evolved Packet System (EPS) 200 or other appropriate terms. The 5GS/EPS 200 may comprise one or more UEs 201, a UE 241 that is in Sidelink communications with a UE 201, an NG-RAN 202, a 5G-Core Network/Evolved Packet Core (5GC/EPC) 210, a Home Subscriber Server (HSS)/Unified Data Management (UDM) 220 and an Internet Service 230. The 5GS/EPS 200 may be interconnected with other access networks. For simple description, the entities/interfaces are not shown. As shown in FIG. 2, the 5GS/EPS 200 provides packet switching services. Those skilled in the art will find it easy to understand that various concepts presented throughout the present application can be extended to networks providing circuit switching services. The NG-RAN 202 comprises an NR node B (gNB) 203 and other gNBs 204. The gNB 203 provides UE 201-oriented user plane and control plane protocol terminations. The gNB 203 may be connected to other gNBs 204 via an Xn interface (for example, backhaul). The gNB 203 may be called a base station, a base transceiver station, a radio base station, a radio transceiver, a transceiver function, a Base Service Set (BSS), an Extended Service Set (ESS), a Transmitter Receiver Point (TRP) or some other applicable terms. The gNB 203 provides an access point of the 5GC/EPC 210 for the UE 201. Examples of the UE 201 include cellular phones, smart phones, Session Initiation Protocol (SIP) phones, laptop computers, Personal Digital Assistant (PDA), Satellite Radios, Global Positioning Systems (GPSs), multimedia devices, video devices, digital audio players (for example, MP3 players), cameras, game consoles, unmanned aerial vehicles (UAV), aircrafts, narrow-band physical network devices, machine-type communication devices, land vehicles, automobiles, wearable devices, or any other devices having similar functions. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy, a mobile client, a client or some other appropriate terms. The gNB 203 is connected to the 5GC/EPC 210 via an SI/NG interface. The 5GC/EPC 210 comprises a Mobility Management Entity (MME)/Authentication Management Field (AMF)/Session Management Function (SMF) 211, other MMEs/AMFs/SMFs 214, a Service Gateway (S-GW)/User Plane Function (UPF) 212 and a Packet Date Network Gateway (P-GW)/UPF 213. The MME/AMF/SMF 211 is a control node for processing a signaling between the UE 201 and the 5GC/EPC 210. Generally, the MME/AMF/SMF 211 provides bearer and connection management. All user Internet Protocol (IP) packets are transmitted through the S-GW/UPF 212, the S-GW/UPF 212 is connected to the P-GW/UPF 213. The P-GW provides UE IP address allocation and other functions. The P-GW/UPF 213 is connected to the Internet Service 230. The Internet Service 230 comprises IP services corresponding to operators, specifically including Internet, Intranet, IP Multimedia Subsystem (IMS) and Packet Switching Services.

In one embodiment, the first node in the present application comprises the UE 201.

In one embodiment, the first node in the present application comprises the UE 241.

In one embodiment, the second node in the present application comprises the gNB 203.

### Embodiment 3

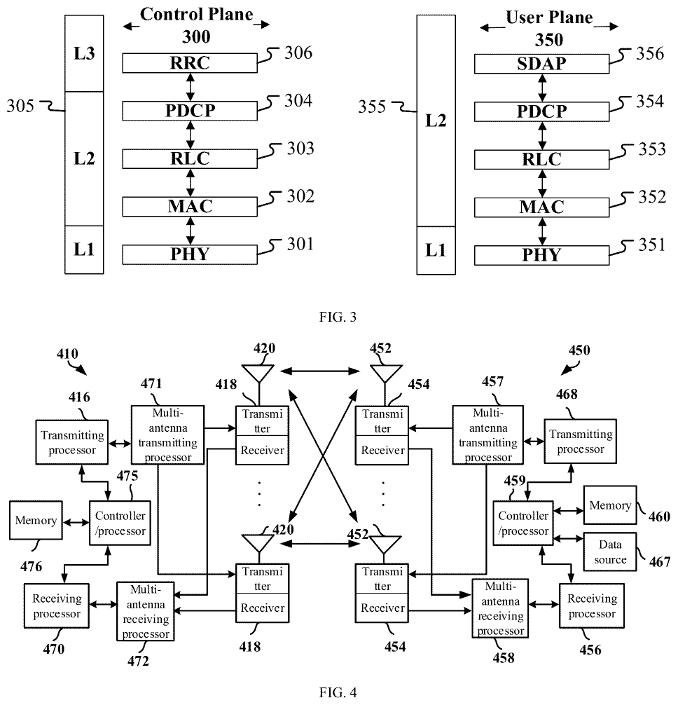

Embodiment 3 illustrates a schematic diagram of a radio protocol architecture of a user plane and a control plane according to one embodiment of the present application, as shown in FIG. 3.

Embodiment 3 illustrates a schematic diagram of an example of a radio protocol architecture of a user plane and a control plane according to one embodiment of the present application, as shown in FIG. 3. FIG. 3 is a schematic diagram illustrating an embodiment of a radio protocol architecture of a user plane 350 and a control plane 300. In FIG. 3, the radio protocol architecture for a first communication node (UE, gNB or an RSU in V2X) and a second communication node (gNB, UE or an RSU in V2X), or between two UEs is represented by three layers, which are a layer 1, a layer 2 and a layer 3, respectively. The layer 1 (L1) is the lowest layer and performs signal processing functions of various PHY layers. The L1 is called PHY 301 in the present application. The layer 2 (L2) 305 is above the PHY 301, and is in charge of a link between a first communication node and a second communication node, or between two UEs. L2 305 comprises a Medium Access Control (MAC) sublayer 302, a Radio Link Control (RLC) sublayer 303 and a Packet Data Convergence Protocol (PDCP) sublayer 304. All the three sublayers terminate at the second communication node. The PDCP sublayer 304 provides multiplexing among variable radio bearers and logical channels. The PDCP sublayer 304 provides security by encrypting a packet and provides support for a first communication node handover between second communication nodes. The RLC sublayer 303 provides segmentation and reassembling of a higher-layer packet, retransmission of a lost packet, and reordering of a data packet so as to compensate the disordered receiving caused by HARQ. The MAC sublayer 302 provides multiplexing between a logical channel and a transport channel. The MAC sublayer 302 is also responsible for allocating between first communication nodes various radio resources (i.e., resource block) in a cell. The MAC sublayer 302 is also in charge of HARQ operation. The Radio Resource Control (RRC) sublayer 306 in layer 3 (L3) of the control plane 300 is responsible for acquiring radio resources (i.e., radio bearer) and configuring the lower layer with an RRC signaling between a second communication node and a first communication node device. The radio protocol architecture of the user plane 350 comprises layer 1 (L1) and layer 2 (L2). In the user plane 350, the radio protocol architecture for the first communication node and the second communication node is almost the same as the corresponding layer and sublayer in the control plane 300 for physical layer 351, PDCP sublayer 354, RLC sublayer 353 and MAC sublayer 352 in L2 layer 355, but the PDCP sublayer 354 also provides a header compression for a higher-layer packet so as to reduce a radio transmission overhead. The L2 layer 355 in the user plane 350 also includes Service Data Adaptation Protocol (SDAP) sublayer 356, which is responsible for the mapping between QoS flow and Data Radio Bearer (DRB) to support the diversity of traffic. Although not described in FIG. 3, the first communication node may comprise several higher layers above the L2 layer 355, such as a network layer (e.g., IP layer) terminated at a P-GW of the network side and an application layer terminated at the other side of the connection (e.g., a peer UE, a server, etc.).

In one embodiment, the radio protocol architecture in FIG. 3 is applicable to the first node in the present application.

In one embodiment, the radio protocol architecture in FIG. 3 is applicable to the second node in the present application.

In one embodiment, the first information block set is generated by the RRC sublayer 306.

In one embodiment, the higher layer in the present application refers to a layer above the physical layer.

### Embodiment 4

Embodiment 4 illustrates a schematic diagram of a first communication device and a second communication device according to one embodiment of the present application, as shown in FIG. 4. FIG. 4 is a block diagram of a first communication device 410 in communication with a second communication device 450 in an access network.

The first communication device 410 comprises a controller/processor 475, a memory 476, a receiving processor 470, a transmitting processor 416, a multi-antenna receiving processor 472, a multi-antenna transmitting processor 471, a transmitter/receiver 418 and an antenna 420.

The second communication device 450 comprises a controller/processor 459, a memory 460, a data source 467, a transmitting processor 468, a receiving processor 456, a multi-antenna transmitting processor 457, a multi-antenna receiving processor 458, a transmitter/receiver 454 and an antenna 452.

In a transmission from the first communication device 410 to the second communication device 450, at the first communication device 410, a higher layer packet from the core network is provided to a controller/processor 475. The controller/processor 475 provides a function of the L2 layer. In DL transmission, the controller/processor 475 provides header compression, encryption, packet segmentation and reordering, and multiplexing between a logical channel and a transport channel, and radio resource allocation for the second communication device 450 based on various priorities. The controller/processor 475 is also in charge of HARQ operation, retransmission of a lost packet, and a signaling to the second communication node 450. The transmitting processor 416 and the multi-antenna transmitting processor 471 perform various signal processing functions used for the L1 layer (that is, PHY). The transmitting processor 416 performs coding and interleaving so as to ensure an FEC (Forward Error Correction) at the second communication device 450, and the mapping to signal clusters corresponding to each modulation scheme (i.e., BPSK, QPSK, M-PSK, M-QAM, etc.). The multi-antenna transmitting processor 471 performs digital spatial precoding, including codebook-based precoding and non-codebook-based precoding, and beamforming on encoded and modulated symbols to generate one or more parallel streams. The transmitting processor 416 then maps each parallel stream into a subcarrier. The mapped symbols are multiplexed with a reference signal (i.e., pilot frequency) in time domain and/or frequency domain, and then they are assembled through Inverse Fast Fourier Transform (IFFT) to generate a physical channel carrying time-domain multicarrier symbol streams. After that the multi-antenna transmitting processor 471 performs transmission analog precoding/beamforming on the time-domain multicarrier symbol streams. Each transmitter 418 converts a baseband multicarrier symbol stream provided by the multi-antenna transmitting processor 471 into a radio frequency (RF) stream. Each radio frequency stream is later provided to different antennas 420.

In a transmission from the first communication device 410 to the second communication device 450, at the second communication device 450, each receiver 454 receives a signal via a corresponding antenna 452. Each receiver 454 recovers information modulated to the RF carrier, converts the radio frequency stream into a baseband multicarrier symbol stream to be provided to the receiving processor 456. The receiving processor 456 and the multi-antenna receiving processor 458 perform signal processing functions of the L1 layer. The multi-antenna receiving processor 458 performs receiving analog precoding/beamforming on a baseband multicarrier symbol stream from the receiver 454. The receiving processor 456 converts the baseband multicarrier symbol stream after receiving the analog precoding/beamforming from time domain into frequency domain using FFT. In frequency domain, a physical layer data signal and a reference signal are de-multiplexed by the receiving processor 456, wherein the reference signal is used for channel estimation, while the data signal is subjected to multi-antenna detection in the multi-antenna receiving processor 458 to recover any second communication device 450-targeted parallel stream. Symbols on each parallel stream are demodulated and recovered in the receiving processor 456 to generate a soft decision. Then the receiving processor 456 decodes and de-interleaves the soft decision to recover the higher-layer data and control signal transmitted on the physical channel by the first communication node 410. Next, the higher-layer data and control signal are provided to the controller/processor 459. The controller/processor 459 performs functions of the L2 layer. The controller/processor 459 can be connected to a memory 460 that stores program code and data. The memory 460 can be called a computer readable medium. In downlink (DownLink) transmission, the controller/processor 459 provides demultiplexing between a transport channel and a logical channel, packet reassembling, decryption, header decompression and control signal processing so as to recover a higher-layer packet from the core network. The higher-layer packet is later provided to all protocol layers above the L2 layer, or various control signals can be provided to the L3 layer for processing. The controller/processor 459 also performs error detection using ACK and/or NACK protocols as a way to support HARQ operation.

In a transmission from the second communication device 450 to the first communication device 410, at the second communication device 450, the data source 467 is configured to provide a higher-layer packet to the controller/processor 459. The data source 467 represents all protocol layers above the L2 layer. Similar to a transmitting function of the first communication device 410 described in DL transmission, the controller/processor 459 performs header compression, encryption, packet segmentation and reordering, and multiplexing between a logical channel and a transport channel based on radio resource allocation of the first communication device 410 so as to provide the L2 layer functions used for the user plane and the control plane. The controller/processor 459 is also responsible for HARQ operation, retransmission of a lost packet, and a signaling to the first communication device 410. The transmitting processor 468 performs modulation mapping and channel coding. The multi-antenna transmitting processor 457 implements digital multi-antenna spatial precoding, including codebook-based precoding and non-codebook-based precoding, as well as beamforming. Following that, the generated parallel streams are modulated into multicarrier/single-carrier symbol streams by the transmitting processor 468, and then modulated symbol streams are subjected to analog precoding/beamforming in the multi-antenna transmitting processor 457 and provided from the transmitters 454 to each antenna 452. Each transmitter 454 first converts a baseband symbol stream provided by the multi-antenna transmitting processor 457 into a radio frequency symbol stream, and then provides the radio frequency symbol stream to the antenna 452.

In the transmission from the second communication device 450 to the first communication device 410, the function of the first communication device 410 is similar to the receiving function of the second communication device 450 described in the transmission from the first communication device 410 to the second communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and multi-antenna receiving processor 472 collectively provide functions of the L1 layer. The controller/processor 475 provides functions of the L2 layer. The controller/processor 475 can be connected with the memory 476 that stores program code and data. The memory 476 can be called a computer readable medium. the controller/processor 475 provides de-multiplexing between a transport channel and a logical channel, packet reassembling, decryption, header decompression, control signal processing so as to recover a higher-layer packet from the second communication device 450. The higher-layer packet coming from the controller/processor 475 may be provided to the core network. The controller/processor 475 can also perform error detection using ACK and/or NACK protocols to support HARQ operation.

In one embodiment, the second communication device 450 comprises at least one processor and at least one memory. The at least one memory comprises computer program codes: the at least one memory and the computer program codes are configured to be used in collaboration with the at least one processor. The second communication device 450 at least: receives a first information block set, the first information block set is used to configure multiple CORESETs, the multiple CORESETs are configured to N cells, N being a positive integer greater than 1: determines a first CORESET from the multiple CORESETs, monitors a PDCCH in only a target CORESET group in the multiple CORESETs in a first time window; the first time window consists of multiple overlapping PDCCH monitoring occasions, the multiple overlapping PDCCH monitoring occasions respectively comprise time-domain resources occupied by PDCCH candidates in the multiple CORESETs; herein, the target CORESET group comprises each CORESET having same QCL properties as the first CORESET among the multiple CORESETs: each of the N cells comprises at least one of two types of symbols in the first time window: a determination of the first CORESET depends on whether at least one of the N cells comprises a first-type symbol in the first time window, and the first-type symbol is one of the two types of symbols.

In one embodiment, the second communication device 450 comprises a memory that stores a computer readable instruction program. The computer readable instruction program generates an action when executed by at least one processor. The action includes: receiving a first information block set, the first information block set being used to configure multiple CORESETs, the multiple CORESETs being configured to N cells, N being a positive integer greater than 1: determining a first CORESET from the multiple CORESETs, monitoring a PDCCH in only a target CORESET group in the multiple CORESETs in a first time window, the first time window consisting of multiple overlapping PDCCH monitoring occasions, the multiple overlapping PDCCH monitoring occasions respectively comprising time-domain resources occupied by PDCCH candidates in the multiple CORESETs: herein, the target CORESET group comprises each CORESET having same QCL properties as the first CORESET among the multiple CORESETs: each of the N cells comprises at least one of two types of symbols in the first time window: a determination of the first CORESET depends on whether at least one of the N cells comprises a first-type symbol in the first time window, and the first-type symbol is one of the two types of symbols.

In one embodiment, the first communication device 410 comprises at least one processor and at least one memory. The at least one memory comprises computer program codes: the at least one memory and the computer program codes are configured to be used in collaboration with the at least one processor. The first communication device 410 at least: transmits a first information block set, the first information block set is used to configure multiple CORESETs, the multiple CORESETs are configured to N cells, N being a positive integer greater than 1: herein, a receiver of the first information block set determines a first CORESET from the multiple CORESETs, and monitors a PDCCH in only a target CORESET group in the multiple CORESETs in a first time window: the first time window consists of multiple overlapping PDCCH monitoring occasions, the multiple overlapping PDCCH monitoring occasions respectively comprise time-domain resources occupied by PDCCH candidates in the multiple CORESETs: the target CORESET group comprises each CORESET having same QCL properties as the first CORESET among the multiple CORESETs: each of the N cells comprises at least one of two types of symbols in the first time window: a determination of the first CORESET depends on whether at least one of the N cells comprises a first-type symbol in the first time window, and the first-type symbol is one of the two types of symbols.

In one embodiment, the first communication device 410 comprises a memory that stores a computer readable instruction program. The computer readable instruction program generates an action when executed by at least one processor. The action includes: transmitting a first information block set, the first information block set being used to configure multiple CORESETs, the multiple CORESETs being configured to N cells, N being a positive integer greater than 1: herein, a receiver of the first information block set determines a first CORESET from the multiple CORESETs, and monitors a PDCCH in only a target CORESET group in the multiple CORESETs in a first time window: the first time window consists of multiple overlapping PDCCH monitoring occasions, the multiple overlapping PDCCH monitoring occasions respectively comprise time-domain resources occupied by PDCCH candidates in the multiple CORESETs: the target CORESET group comprises each CORESET having same QCL properties as the first CORESET among the multiple CORESETs: each of the N cells comprises at least one of two types of symbols in the first time window: a determination of the first CORESET depends on whether at least one of the N cells comprises a first-type symbol in the first time window, and the first-type symbol is one of the two types of symbols.

In one embodiment, the first node comprises the second communication device 450 in the present application.

In one embodiment, the second node in the present application comprises the first communication device 410.

In one embodiment, at least one of the antenna 452, the receiver 454, the receiving processor 456, the multi-antenna receiving processor 458, the controller/processor 459, the memory 460, or the data source 467 is used to receive the first information block set in the present application: at least one of the antenna 420, the transmitter 418, the transmitting processor 416, the multi-antenna transmitting processor 471, the controller/processor 475, or the memory 476 is used to transmit the first information block set in the present application.

In one embodiment, at least one of the antenna 452, the receiver 454, the receiving processor 456, the multi-antenna receiving processor 458, the controller/processor 459, the memory 460, or the data source 467 is used to monitor a PDCCH in only the target CORESET group in the multiple CORESETs in the first time window in the present application.

In one embodiment, at least one of the antenna 452, the receiver 454, the receiving processor 456, the multi-antenna receiving processor 458, the controller/processor 459, the memory 460, or the data source 467 is used to determine the first CORESET from the multiple CORESETs in the present application.

In one embodiment, at least one of the receiving processor 456, the multi-antenna receiving processor 458, the controller/processor 459, the memory 460, or the data source 467 is used to determine the first CORESET from the multiple CORESETs in the present application.

In one embodiment, at least one of the antenna 452, the receiver 454, the receiving processor 456, the multi-antenna receiving processor 458, the controller/processor 459, the memory 460, or the data source 467 is used to determine the second CORESET in the present application.

In one embodiment, at least one of the receiving processor 456, the multi-antenna receiving processor 458, the controller/processor 459, the memory 460, or the data source 467 is used to determine the second CORESET in the present application.

### Embodiment 5

Embodiment 5 illustrates a flowchart of wireless transmission according to one embodiment in the present application, as shown in FIG. 5. In FIG. 5, the first node U1 and the second node N2 are respectively two communication nodes transmitted through an air interface, where the steps in box F51 are optional.

The first node U1 receives a first information block set in step S5101: determines a first CORESET from multiple CORESETs in step S5102: determines a second CORESET in step S5103; monitors a PDCCH in only target CORESET group in the multiple CORESETs in a first time window in step S5104:

The second node N2 transmits a first information block set in step S5201.

In embodiment 5, the first information block set is used to configure multiple CORESETs, and the multiple CORESETs are configured to N cells, N being a positive integer greater than 1: the first time window consists of multiple overlapping PDCCH monitoring occasions, the multiple overlapping PDCCH monitoring occasions respectively comprise time-domain resources occupied by PDCCH candidates in the multiple CORESETs: the target CORESET group comprises each CORESET having same QCL properties as the first CORESET among the multiple CORESETs; each of the N cells comprises at least one of two types of symbols in the first time window: a determination of the first CORESET depends on whether at least one of the N cells comprises a first-type symbol in the first time window, and the first-type symbol is one of the two types of symbols.

In one embodiment, the first node U1 is the first node in the present application.

In one embodiment, the second node N2 is the second node in the present application.

In one embodiment, an air interface between the second node N2 and the first node U1 comprises a radio interface between a base station and a UE.

In one embodiment, an air interface between the second node N2 and the first node U1 comprises a radio interface between a relay node and a UE.

In one embodiment, an air interface between the second node N2 and the first node U1 comprises a radio interface between a UE and a UE.

In one embodiment, a physical channel occupied by the first information block set comprises a PDSCH (Physical Downlink Shared Channel).

In one embodiment, a reception of the first information block set is earlier than a start time of the first time window.

In one embodiment, steps in block F51 in FIG. 5 exist, and the above method in a first node U1 for wireless communications comprises: determining a second CORESET: herein, the second CORESET is one of the multiple CORESETs, and QCL properties of the second CORESET are different from QCL properties of the first CORESET: the target CORESET group also comprises each CORESET having same QCL properties as the second CORESET among the multiple CORESETs.

In one embodiment, the second node transmits a first signaling in the target CORESET group within the first time window.

In one subembodiment of the above embodiment, the first signaling is transmitted on a Physical Downlink Control Channel (PDCCH).

In one subembodiment of the above embodiment, the first signaling is a control signaling.

In one subembodiment of the above embodiment, the first signaling is a DCI signaling.

In one embodiment, advantages of the above method include: in the first time window, a UE only monitors a PDCCH in the target CORESET group, and the second node transmits a first signaling in the target CORESET group, ensuring UE's monitoring of the first signaling.

In one embodiment, whether the second node transmits a PDCCH among the multiple CORESETs in the first time window is related to the implementation of the second node.

In one embodiment, in the first time window, in which CORESET among the multiple CORESETs a PDCCH is transmitted by the second node is related to the implementation of the second node.

In one embodiment, in the first time window, the second node transmits a PDCCH in only the target CORESET group in the multiple CORESETs.

In one embodiment, advantages of the above method include: in the first time window, the UE only monitors a PDCCH in the target CORESET group, reducing implementation complexity, and the second node transmits a PDCCH in only the target CORESET group, ensuring the UE's monitoring of PDCCH.

### Embodiment 6

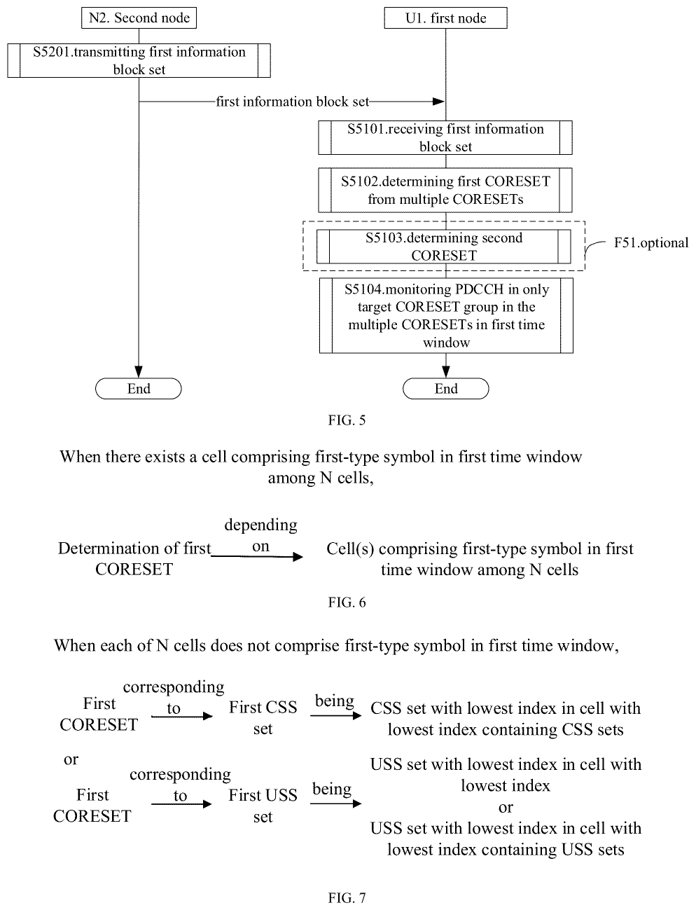

Embodiment 6 illustrates a schematic diagram of a determination of a first CORESET according to one embodiment of the present application, as shown in FIG. 6.

In embodiment 6, when there exists a cell comprising the first-type symbol in the first time window among the N cells, a determination of the first CORESET depends on cell(s) comprising the first-type symbol in the first time window among the N cells.

In one embodiment, only when there exists a cell comprising the first-type symbol in the first time window among the N cells, a determination of the first CORESET depends on cell(s) comprising the first-type symbol in the first time window among the N cells.

In one embodiment, only when each symbol in one of the N cells in a first time window is the first-type symbol, a determination of the first CORESET depends on a cell comprising the first-type symbol in the first time window among the N cells.

In one embodiment, only when at least one symbol in one of the N cells in a first time window is the first-type symbol, a determination of the first CORESET depends on a cell comprising the first-type symbol in the first time window among the N cells.

### Embodiment 7

Embodiment 7 illustrates a schematic diagram of relations among a first CORESET, a first CSS set and a first USS set according to one embodiment of the present application, as shown in FIG. 7.

In embodiment 7, when each of the N cells does not comprise the first-type symbol in the first time window, the first CORESET corresponds to a first CSS set, the first CSS set being a CSS set with lowest index in a cell with lowest index containing CSS sets, or the first CORESET corresponds to a first USS set, the first USS set being a USS set with lowest index in a cell with lowest index or the first USS set being a USS set with lowest index in a cell with lowest index containing USS sets.

In one subembodiment of the above embodiment, when there exists one CORESET corresponding to a CSS (Common search space) set in multiple CORESETs, the first CORESET corresponds to a first CSS set; when each of the multiple CORESETs corresponds to a USS set, the first CORESET corresponds to a first USS (UE-specific search space) set.

In one subembodiment of the above embodiment, when any PDCCH candidate among the multiple CORESETs in the first time window does not belong to a CSS set, the first CORESET corresponds to a first USS set.

In one subembodiment of the above embodiment, when each of the multiple CORESETs does not correspond to a CSS set, the first CORESET corresponds to a first USS set.

In one subembodiment of the above embodiment, when there exists at least one PDCCH candidate belonging to a CSS set among the multiple CORESETs in the first time window, the first CORESET corresponds to a first CSS set.

In one embodiment, when each of the N cells does not comprise the first-type symbol in the first time window, the first CORESET corresponds to the first CSS set, and the first CSS set is a CSS set with lowest index in a cell with the lowest index comprising CSS sets.

In one embodiment, when each of the N cells does not comprise the first-type symbol in the first time window, the first CORESET corresponds to a first USS set, the first USS set is a USS set with lowest index in a cell with lowest index or the first USS set is a USS set with lowest index in a cell with lowest index comprising USS sets.

In one embodiment, when each of the N cells does not comprise the first-type symbol in the first time window, the first CORESET corresponds to a first USS set, and the first USS set is a USS set with lowest index in a cell with the lowest index.

In one embodiment, when each of the N cells does not comprise the first-type symbol in the first time window, the first CORESET corresponds to a first USS set, and the first USS set is a USS set with lowest index in a cell with the lowest index comprising USS sets.

In one embodiment, the meaning of “there existing a CORESET corresponding to a CSS set among the multiple CORESETs” comprises: there exists one CORESET corresponding to a CSS set among the multiple CORESETs, and at least one PDCCH candidate in the CSS set belongs to one PDCCH monitoring occasion in the first time window in time domain.

In one embodiment, “there existing a CORESET corresponding to a CSS set among the multiple CORESETs” comprises: there exists one CORESET corresponding to a CSS set comprising a PDCCH candidate in the first time window among the multiple CORESETs.

In one embodiment, “there existing a CORESET corresponding to a CSS set among the multiple CORESETs” comprises: the multiple CORESETs correspond to multiple SS sets of the N cells, and the multiple SS sets comprise at least one CSS set.

In one embodiment, the meaning of “there existing a CORESET corresponding to a CSS set among the multiple CORESETs” comprises: the multiple CORESETs correspond to multiple SS sets of the N cells, any SS set in the multiple SS sets comprises at least one PDCCH candidate in the first time window, and at least one SS set in the multiple SS sets is a CSS set: the meaning of “each CORESET in the multiple CORESETs not corresponding to a CSS set” comprises: the multiple CORESETs correspond to multiple SS sets of the N cells, and any SS set in the multiple SS sets comprises at least one PDCCH candidate in the first time window; each SS set in the multiple SS sets is not a CSS set, or each SS set in the multiple SS sets is a USS set.

In one embodiment, the meaning of “there existing a CORESET corresponding to a CSS set among the multiple CORESETs” comprises: the multiple CORESETs correspond to multiple SS sets of the N cells, and any SS set in the multiple SS sets comprises at least one PDCCH candidate in a PDCCH monitoring occasion in the first time window, and at least one SS set in the multiple SS sets is a CSS set: the meaning of “each CORESET in the multiple CORESETs not corresponding to a CSS set” comprises: the multiple CORESETs correspond to multiple SS sets of the N cells, and any SS set in the multiple SS sets comprises at least one PDCCH candidate in a PDCCH monitoring occasion in the first time window; each SS set in the multiple SS sets is not a CSS set, or each SS set in the multiple SS sets is a USS set.

In one embodiment, “each CORESET in the multiple CORESETs not corresponding to a CSS set” comprises: the multiple CORESETs correspond to multiple SS sets of the N cells, and each SS set in the multiple SS sets are not a CSS set.

In one embodiment, “the first CSS set being a CSS set with lowest index in a cell with the lowest index comprising CSS sets” comprises: the multiple CORESETs correspond to multiple SS sets of N cells: the first CSS set is a CSS set with lowest index in a first cell, and the first cell is a cell with lowest index comprising CSS sets in the multiple SS sets among the N cells.

In one embodiment, “the first CSS set being a CSS set with lowest index in a cell with the lowest index comprising CSS sets” comprises: the multiple CORESETs correspond to multiple SS sets of the N cells: any SS set in the multiple SS sets comprises at least one PDCCH candidate in the first time window, or any SS set in the multiple SS sets comprises at least one PDCCH candidate in a PDCCH monitoring occasion in the first time window: the first CSS set is a CSS set with lowest index in a first cell, and the first cell is a cell with lowest index comprising CSS sets in the multiple SS sets among the N cells.

In one embodiment, the first CSS set is determined in all CSS sets comprising at least one PDCCH candidate in the first time window.

In one embodiment, “the first USS set is a USS set with lowest index in a cell with lowest index” comprises: the first USS set is a USS set with the lowest index in a cell with lowest index among the N cells.

In one embodiment, “the first USS set is a USS set with lowest index in a cell with lowest index” comprises: the first USS set is a USS set with lowest index that satisfies “comprising at least one PDCCH candidate in the first time window” in a cell with lowest index among the N cells.

In one embodiment, “the first USS set is a USS set with lowest index in a cell with lowest index comprising USS sets” comprises: the first USS set is a USS set with lowest index in a cell with lowest index comprising USS sets among the N cells.

In one embodiment, “the first USS set is a USS set with lowest index in a cell with lowest index comprising USS sets” comprises: the first USS set is a USS set with lowest index that satisfies “comprising at least one PDCCH candidate in the first time window” in a cell with lowest index comprising USS sets among the N cells.

In one embodiment, the first USS set is determined over all USS sets with at least one PDCCH candidate in overlapping PDCCH monitoring occasions.

### Embodiment 8

Embodiment 8 illustrates a schematic diagram of relations among a first CORESET, a second CSS set and a second USS set according to one embodiment of the present application, as shown in FIG. 8, the N cells in FIG. 8 are respectively Cell #0, Cell #1, Cell #2 . . . . Cell #N-1, where Cell #1 and Cell #2 comprise the first-type symbol in the first time window, and Cell #1 and Cell #2 belong to a first cell subgroup.

In embodiment 8, when there exists a cell comprising the first-type symbol in the first time window among the N cells, a first cell subgroup comprises cell(s) comprising the first-type symbol in the first time window among the N cells; the first CORESET corresponds to a second CSS set, the second CSS set being a CSS set in the first cell subgroup, or the first CORESET corresponds to a second USS set, the second USS set being a USS set in the first cell subgroup.

In one embodiment, when there exists a cell comprising the first-type symbol in the first time window among the N cells, a first cell subgroup comprises cell(s) comprising the first-type symbol in the first time window among the N cells; the first CORESET corresponds to a second CSS set, and the second CSS set is a CSS set in the first cell subgroup.

In one embodiment, when there exists a cell comprising the first-type symbol in the first time window among the N cells, a first cell subgroup comprises cell(s) comprising the first-type symbol in the first time window among the N cells; the first CORESET corresponds to a second USS set, and the second USS set is a USS set in the first cell subgroup.

In one embodiment, a first cell subgroup only comprises a cell comprising the first-type symbol in the first time window among the N cells.

In one embodiment, a first cell subgroup comprises all cells comprising the first-type symbol in the first time window among the N cells.

In one embodiment, each cell comprising the first-type symbol in the first time window among the N cells belongs to a first cell subgroup.

In one embodiment, when each symbol comprised in one of the N cells in the first time window is the first-type symbol, a first cell subgroup comprises a cell comprising the first-type symbol in the first time window among the N cells.

In one embodiment, when there exist partial symbols comprised in one of the N cells being the first-type symbol in the first time window, a first cell subgroup comprises a cell comprising the first-type symbol in the first time window among the N cells.

In one embodiment, when there exists each symbol comprised in the first time window in multiple cells in the N cells being the first-type symbol, a first cell subgroup comprises a cell comprising the first-type symbol in the first time window among the N cells.

In one embodiment, when there exist partial symbols comprised in the first time window in multiple cells in the N cells being the first-type symbol, a first cell subgroup comprises a cell comprising the first-type symbol in the first time window among the N cells.

In one embodiment, a first CORESET subgroup comprises all CORESETs configured for a cell in the first cell subgroup among the multiple CORESETs: when there exists a CORESET corresponding to a CSS set in the first CORESET subgroup, the first CORESET corresponds to the second CSS set; when each CORESET in the first CORESET subgroup corresponds to a USS set, the first CORESET corresponds to the second USS set.

In one subembodiment of the above embodiment, when any PDCCH candidate in the first CORESET subgroup in the first time window does not belong to a CSS set, the first CORESET corresponds to a second USS set.

In one subembodiment of the above embodiment, when CORESET in the first CORESET subgroup does not correspond to a CSS set, the first CORESET corresponds to a second USS set.

In one subembodiment of the above embodiment, when there exists at least one PDCCH candidate belonging to a CSS set in the first CORESET subgroup in the first time window, the first CORESET corresponds to a second CSS set.

In one embodiment, the meaning of “there existing a CORESET corresponding to a CSS set in the first CORESET subgroup” comprises: there exists a CORESET corresponding to a CSS set in the first CORESET subgroup, and at least one PDCCH candidate in the CSS set belongs to a PDCCH monitoring occasion in the first time window in time domain.

In one embodiment, “there existing a CORESET corresponding to a CSS set in the first CORESET subgroup” comprises: there exists a CORESET corresponding to a CSS set comprised in a PDCCH candidate in the first time window in the first CORESET subgroup.

In one embodiment, “there existing a CORESET corresponding to a CSS set in the first CORESET subgroup” comprises: the first CORESET subgroup corresponds to multiple SS sets of N cells, and the multiple SS sets comprise at least one CSS set.

In one embodiment, the meaning of “there existing a CORESET corresponding to a CSS set in the first CORESET subgroup” comprises: the first CORESET subgroup corresponds to multiple SS sets of the N cells, and any SS set in the multiple SS sets comprises at least one PDCCH candidate in the first time window, and at least one SS set in the multiple SS sets is a CSS set: the meaning of “each CORESET in the first CORESET subgroup not corresponding to a CSS set” comprises: the first CORESET subgroup corresponds to multiple SS sets of the N cells, and any SS set in the multiple SS sets comprises at least one PDCCH candidate in the first time window: each SS set in the multiple SS sets is not a CSS set, or each SS set in the multiple SS sets is a USS set.

In one embodiment, the meaning of “there existing a CORESET in the first CORESET subgroup corresponding to a CSS set” comprises: the first CORESET subgroup corresponds to multiple SS sets of the N cells, and any SS set in the multiple SS sets comprises at least one PDCCH candidate in a PDCCH monitoring occasion in the first time window, and at least one SS set in the multiple SS sets is a CSS set: the meaning of “each CORESET in the first CORESET subgroup not corresponding to a CSS set” comprises: the first CORESET subgroup corresponds to multiple SS sets of the N cells, and any SS set in the multiple SS sets comprises at least one PDCCH candidate in a PDCCH monitoring occasion in the first time window: each SS set in the multiple SS sets is not a CSS set, or each SS set in the multiple SS sets is a USS set.

In one embodiment, “each CORESET in the first CORESET subgroup not corresponding to a CSS set” comprises: the first CORESET subgroup corresponds to multiple SS sets of the N cells, and each SS set in the multiple SS sets is not a CSS set.

In one embodiment, the second CSS set is a CSS set with lowest index in “a cell with lowest index comprising CSS sets” in the first cell subgroup.

In one embodiment, “the second CSS set being a CSS set with lowest index in a cell with lowest index containing CSS sets in the first cell subgroup” comprises: the multiple CORESETs correspond to multiple SS sets of the N cells: the second CSS set is a CSS set with lowest index in a second cell, and the second cell is a cell with lowest index comprising CSS sets in the multiple SS sets in the first cell subgroup.

In one embodiment, “the second CSS set being a CSS set with lowest index in a cell with lowest index containing CSS sets in the first cell subgroup” comprises: the multiple CORESETs correspond to multiple SS sets of the N cells: any SS set in the multiple SS sets comprises at least one PDCCH candidate in the first time window, or any SS set in the multiple SS sets comprises at least one PDCCH candidate in a PDCCH monitoring occasion in the first time window: the second CSS set is a CSS set with lowest index in a second cell, and the second cell is a cell with lowest index comprising CSS sets in the multiple SS sets in the first cell subgroup.

In one embodiment, the second CSS set is determined among all CSS sets comprising at least one PDCCH candidate in the first time window.

In one embodiment, the second USS set is a USS set with lowest index in “a cell with lowest index in the first cell subgroup”.

In one embodiment, the second USS set is a USS set with lowest index in “a cell with lowest index comprising a USS set in the first cell subgroup”.

In one embodiment, “the second USS set is a USS set with lowest index in a cell with lowest index in the first cell subgroup” comprises: the second USS set is a USS set with the lowest index in a cell with lowest index in the first cell subgroup.

In one embodiment, “the second USS set is a USS set with lowest index in a cell with lowest index in the first cell subgroup” comprises: the second USS set is a USS set with lowest index that satisfies “comprising at least one PDCCH candidate in the first time window” in a cell with lowest index in the first cell subgroup.

In one embodiment, “the second USS set is a USS set with lowest index in a cell with lowest index comprising USS sets in the first cell subgroup” comprises: the second USS set is a USS set with the lowest index in a cell with lowest index comprising USS sets in the first cell subgroup.

In one embodiment, “the second USS set is a USS set with lowest index in a cell with lowest index comprising USS sets in the first cell subgroup” comprises: the second USS set is a USS set with lowest index that satisfies “comprising at least one PDCCH candidate in the first time window” in a cell with lowest index comprising USS sets in the first cell subgroup.

In one embodiment, the second USS set is determined in all USS sets comprising at least one PDCCH candidate in the first time window in the first cell subgroup.

### Embodiment 9

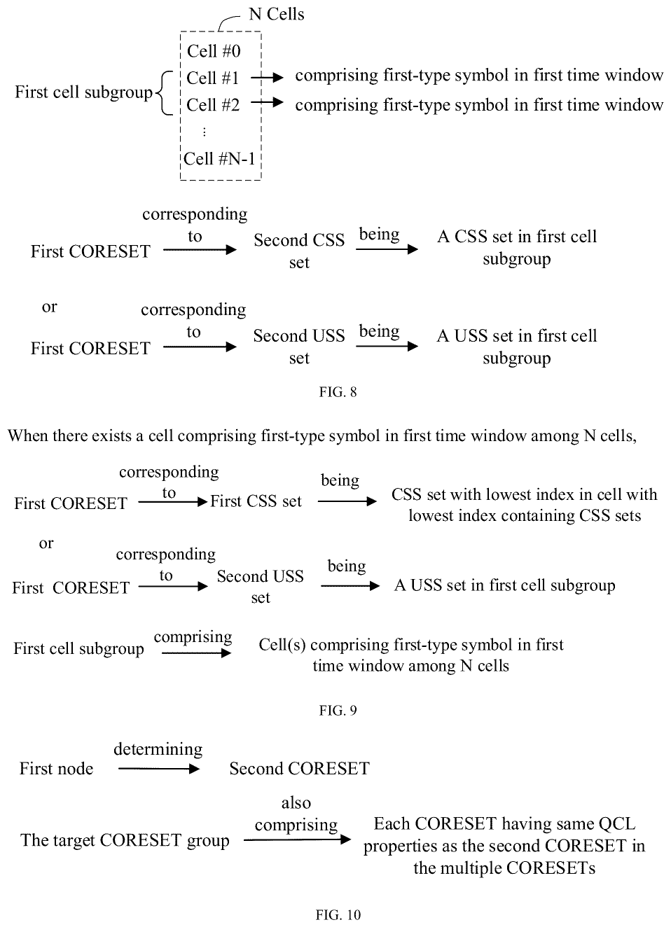

Embodiment 9 illustrates a schematic diagram of relations among a first CORESET, a first CSS set and a second USS set according to one embodiment of the present application, as shown in FIG. 9.

In embodiment 9, when there exists a cell comprising the first-type symbol in the first time window among the N cells, the first CORESET corresponds to a first CSS set, the first CSS set being a CSS set with lowest index in a cell with lowest index containing CSS sets, or the first CORESET corresponds to a second USS set, the second USS set being a USS set in a first cell subgroup, and the first cell subgroup comprising cell(s) comprising the first-type symbol in the first time window among the N cells.

In one embodiment, when there exists one cell comprising the first-type symbol in the first time window among the N cells, the first CORESET corresponds to a first CSS set, and the first CSS set is a CSS set with lowest index in a cell with lowest index containing CSS sets.

In one embodiment, when there exists a cell comprising the first-type symbol in the first time window among the N cells, the first CORESET corresponds to a second USS set, the second USS set is a USS set in a first cell subgroup, and the first cell subgroup comprises a cell comprising the first-type symbol in the first time window among the N cells.

In one embodiment, when there exists one CORESET corresponding to a CSS (Common search space) set in multiple CORESETs, the first CORESET corresponds to a first CSS set: when each of the multiple CORESETs corresponds to a USS set, the first CORESET corresponds to the second USS set.

In one subembodiment of the above embodiment, when any PDCCH candidate in the multiple CORESETs in the first time window does not belong to a CSS set, the first CORESET corresponds to a second USS set.

In one subembodiment of the above embodiment, when each of the multiple CORESETs does not correspond to a CSS set, the first CORESET corresponds to a second USS set.

### Embodiment 10

Embodiment 10 illustrates a schematic diagram of a second CORESET according to one embodiment of the present application, as shown in FIG. 10.

In embodiment 10, the first node in the present application determines a second CORESET: herein, the second CORESET is one of the multiple CORESETs, and QCL properties of the second CORESET are different from QCL properties of the first CORESET: the target CORESET group also comprises each CORESET having same QCL properties as the second CORESET among the multiple CORESETs.

In one embodiment, a determination of the second CORESET is carried out after excluding all CSS sets that satisfy a first condition and all USS sets that satisfy the first condition: the second CORESET corresponds to a third CSS set, or the second CORESET corresponds to a third USS set.

In one embodiment, a determination of the second CORESET is carried out after excluding all CSS sets that satisfy a first condition and all USS sets that satisfy the first condition: the second CORESET corresponds to a third CSS set.

In one embodiment, a determination of the second CORESET is carried out after excluding all CSS sets that satisfy a first condition and all USS sets that satisfy the first condition: the second CORESET corresponds to a third USS set.

In one embodiment, the first condition comprises: a CORESET being associated to has same QCL properties as the first CORESET.

In one embodiment, QCL types of the first CORESET and the second CORESET are set to ‘typeD’.

In one embodiment, the first node is configured with a parameter twoQCLTypeDforPDCCHRepetition.

In one embodiment, searchSpaceLinkingId comprised in an SS set corresponding to the second CORESET has a same value as searchSpaceLinkingId comprised in an SS set corresponding to the first CORESET.

In one embodiment, for the specific meaning of twoQCLTypeDforPDCCHRepetition, refer to chapter 6.3.2 in 3GPP TS 38.331.

In one embodiment, the second CORESET corresponds to the third CSS set, the third CSS set is a CSS set in the first cell subgroup, or the second CORESET corresponds to the third USS set, and the third USS set is a USS set in the first cell subgroup.

In one embodiment, a first CORESET subgroup comprises all CORESETs configured to a cell in the first cell subgroup in the multiple CORESETs: when there exists a CORESET corresponding to a CSS set in the first CORESET subgroup and the CSS set does not satisfy the first condition, the second CORESET corresponds to the third CSS set: when each CORESET in the first CORESET subgroup, except for the first CORESET, corresponds to a USS set, the second CORESET corresponds to the third USS set.

In one embodiment, when any PDCCH candidate in at least one CORESET, except for the first CORESET, comprised in the first CORESET subgroup in the first time window does not belong to a CSS set, the second CORESET corresponds to a third USS set.

In one embodiment, when each CORESET in the first CORESET subgroup, except for the first CORESET, does not correspond to a CSS set, the second CORESET corresponds to a third USS set.

In one embodiment, when at least one PDCCH candidate in at least one CORESET, except for the first CORESET, comprised in the first CORESET subgroup in the first time window belongs to a CSS set, the second CORESET corresponds to a third CSS set.

In one embodiment, the third CSS set is a CSS set with lowest index and not satisfying the first condition in “a cell with lowest index comprising CSS sets in the first cell subgroup”.

In one embodiment, “the third CSS set being a CSS set with lowest index and not satisfying the first condition in a cell with lowest index comprising CSS sets in the first cell subgroup” comprises: the multiple CORESETs correspond to multiple SS sets of N cells: the third CSS set is a CSS set with lowest index and not satisfying the first condition in a second cell, and the second cell is a cell with lowest index comprising CSS sets in the multiple SS sets in the first cell subgroup.

In one embodiment, “the third CSS set being a CSS set with lowest index and not satisfying the first condition in a cell with lowest index comprising CSS sets in the first cell subgroup” comprises: the multiple CORESETs correspond to multiple SS sets of the N cells: any SS set in the multiple SS sets comprises at least one PDCCH candidate in the first time window, or any SS set in the multiple SS sets comprises at least one PDCCH candidate in a PDCCH monitoring occasion in the first time window: the third CSS set is a CSS set with lowest index and not satisfying the first condition in a second cell, and the second cell is a cell with lowest index comprising CSS sets in the multiple SS sets in the first cell subgroup.

In one embodiment, the third CSS set is determined in all CSS sets not satisfying the first condition comprising at least one PDCCH candidate in the first time window.

In one embodiment, the third USS set is a USS set with lowest index and not satisfying the first condition in “a cell with lowest index in the first cell subgroup”.

In one embodiment, the third USS set is a USS set with lowest index and not satisfying the first condition in “a cell with lowest index comprising USS sets in the first cell subgroup”.

In one embodiment, “the third USS set is a USS set with lowest index and not satisfying the first condition in a cell with lowest index in the first cell subgroup” comprises: the third USS set is a USS set with the lowest index and not satisfying the first condition in a cell with lowest index comprising USS sets in the first cell subgroup.

In one embodiment, “the third USS set is a USS set with lowest index and not satisfying the first condition in a cell with lowest index in the first cell subgroup” comprises: the third USS set is a USS set with lowest index not satisfying the first condition and satisfying “comprising at least one PDCCH candidate in the first time window” in a cell with lowest index in the first cell subgroup.

In one embodiment, “the third USS set is a USS set with lowest index and not satisfying the first condition in a cell with lowest index comprising USS sets in the first cell subgroup” comprises: the third USS set is a USS set with lowest index not satisfying the first condition and satisfying “comprising at least one PDCCH candidate in the first time window” in a cell with lowest index comprising USS sets in the first cell subgroup.

In one embodiment, the third USS set is determined in all USS sets not satisfying the first condition comprising at least one PDCCH candidate in the first time window in the first cell subgroup.

In one embodiment, the target CORESET group comprises one or more CORESETs having two activated TCI states.

In one embodiment, when there exists one CORESET having two activated TCI states in the target CORESET group, the first node reports sfn-QCL-TypeD-Collision-twoTCI.

In one embodiment, for the specific meaning of sfn-QCL-TypeD-Collision-twoTCI, refer to chapter 6.3.2 in 3GPP TS 38.331.

### Embodiment 11

Embodiment 11 illustrates a schematic diagram of two types of symbols according to one embodiment of the present application, as shown in FIG. 11.

In embodiment 11, the two types of symbols are configured by higher-layer parameters as DL: uplink transmission is supported on one or more resource blocks (RBs) in only the first-type symbol of the two types of symbols, or the other type of symbol in the two types of symbols that is not the first-type symbol is only used for downlink transmission, and at least a part of first-type symbols in a cell comprising the first-type symbol is used for uplink transmission.

In one embodiment, uplink transmission is supported on one or more Resource Blocks (RBs) in only the first-type symbol in the two types of symbols.

In one embodiment, the other type of symbol in the two types of symbols that is not the first-type symbol is only used for downlink transmission, and at least a part of first-type symbols in a cell comprising the first-type symbol is used for uplink transmission.

In one embodiment, the first node comprises:
the first receiver, receiving a second information block set;
herein, at least one of the N cells comprises at least one first-type symbol, and the second information block set is used to determine a position of the first-type symbol comprised in each cell in the at least one cell.

In one embodiment, “a position of the first-type symbol” refers to: an index of the first-type symbol.

In one embodiment, “a position of the first-type symbol” refers to: symbol occupied by the first-type symbol.

In one embodiment, “a position of the first-type symbol” refers to: time-domain resources occupied by the first-type symbol.

In one embodiment, “a position of the first-type symbol” refers to: a period of the first-type symbol.

In one embodiment, “a position of the first-type symbol” refers to: a time offset of the first-type symbol.

In one embodiment, “a position of the first-type symbol” refers to: a period and time offset of the first-type symbol.

In one embodiment, “a position of the first-type symbol” refers to: time-domain resources comprised in the first-type symbol within a period.

In one embodiment, “a position of the first-type symbol” refers to: symbols comprised in the first-type symbol within a period.

In one embodiment, “a position of the first-type symbol” refers to: slots comprised in the first-type symbol within a period.

In one embodiment, the second information block set is carried by a higher-layer signaling.

In one embodiment, the second information block set is carried by an RRC (Radio Resource Control) signaling.

In one embodiment, the second information block set comprises all or partial fields in an RRC IE (Information Element).

In one embodiment, the second information block set comprises all or partial fields in each RRC IE in multiple RRC IEs.

In one embodiment, the second information block set comprises all or partial fields in a TDD-UL-DL-ConfigCommon IE.

In one embodiment, the second information block set comprises all or partial fields in a TDD-UL-DL-ConfigDedicated IE.

In one embodiment, the second information block set comprises all or partial fields in a ServingCellConfig IE.

In one embodiment, the second information block set comprises all or partial fields in a Serving CellConfigCommonSIB IE.

In one embodiment, the second information block set comprises information in all or partial fields in a ServingCellConfigCommon IE.

In one embodiment, the second information block set is carried by at least one RRC IE.

In one embodiment, a name of an IE carrying the second information block set comprises TDD-UL-DL-Configure.

In one embodiment, a name of an IE carrying the second information block set comprises ServingCellConfig.

In one embodiment, the second information block set is carried by a Medium Access Control layer Control Element (MAC CE).

In one embodiment, the second information block set comprises a MAC CE.

In one embodiment, the second information block set is transmitted on a downlink physical layer data channel (i.e., a downlink channel that can be used for bearing physical layer data).

In one embodiment, the second information block set is transmitted on a PDSCH.

In one embodiment, the second information block set is carried by DCI (Downlink control information).

In one embodiment, the second information block set comprises DCI.

In one embodiment, the second information block set comprises one or more fields in a DCI.

In one embodiment, the second information block set is carried by DCI format 2_0.

In one embodiment, the second information block set comprises DCI format 2_0.

In one embodiment, the second information block set is carried by an RRC signaling and a MAC CE together.

In one embodiment, the second information block set is carried by a higher layer signaling and DCI together.

In one embodiment, the second information block set is used by the first node to determine the first-type symbol.

In one embodiment, the second information block set indicates the first-type symbol.

In one embodiment, the second information block set is used to indicate the first-type symbol.

In one embodiment, the second information block set explicitly indicates the first-type symbol.

In one embodiment, the second information block set implicitly indicates the first-type symbol.

In one embodiment, the other type of the two types of symbols that is not the first-type symbol only supports downlink transmission, and only the first-type symbol of the two types of symbols supports downlink transmission and uplink transmission.

In one embodiment, a second-type symbol is the other type of symbol that is not the first-type symbol in the two types of symbols.

In one embodiment, the second-type symbol is configured as DL by higher-layer parameters and used for downlink transmission in all RBs within a cell.

In one embodiment, the second-type symbol is configured as DL or Flexible by higher-layer parameters and used for downlink transmission in all RBs within a cell.

In one embodiment, in a cell, any symbol occupied by an uplink transmission is orthogonal to the second-type symbol in the two types of symbols, and there exists an uplink transmission occupying at least part of first-type symbol in the cell.

In one embodiment, in a cell, all first-type symbols are used for uplink transmission.

In one embodiment, in a cell, at least part of all first-type symbols are used for uplink transmission.

In one embodiment, in a cell, at least one first-type symbol is used for an uplink transmission for the first node, and at least one first-type symbol is used for a downlink transmission for the first node.

In one embodiment, in a cell, there exists at least one first-type symbol used for uplink transmission for the first node and downlink transmission for a UE other than the first node.

In one embodiment, in a cell comprising the first-type symbol, whether a first-type symbol is used for uplink transmission is related to the implementation of the base station.

In one embodiment, in a cell comprising the first-type symbol, whether a first-type symbol is used for uplink transmission is determined according to base station scheduling.

In one embodiment, “the first-type symbol supporting an uplink transmission” comprises: the first-type symbol is used for uplink transmission.

In one embodiment, “the first-type symbol supporting an uplink transmission” comprises: the first-type symbol is reserved for being used for uplink transmission.

In one embodiment, “the first-type symbol supporting an uplink transmission” comprises: the first-type symbol is configured to be used for uplink transmission.

In one embodiment, “the first-type symbol supporting an uplink transmission” comprises: there exists an uplink transmission occupying at least part of first-type symbol.

In one embodiment, the first-type symbol is configured for both uplink and downlink.

In one embodiment, the first-type symbol is configured for uplink in part of RBs and is configured for downlink in another part of RBs.

In one embodiment, the first-type symbol is used for uplink in part of RBs and is used for downlink in another part of RBs.

In one embodiment, the first-type symbol is configured as DL (DownLink) by higher-layer parameters and is configured to be used for uplink in part of RBs.

In one subembodiment of the above embodiment, a signaling configuring the first-type symbol to be used for uplink in the part of RBs comprises the first information block set.

In one embodiment, the first-type symbol is configured as DL or Flexible by higher-layer parameters and is configured to be used for uplink in part of RBs.

In one subembodiment of the above embodiment, a signaling configuring the first-type symbol to be used for uplink in the part of RBs comprises the first information block set.

In one embodiment, the first-type symbol is configured as DL by higher-layer parameters and is used for uplink in part of RBs.

In one embodiment, the first-type symbol is configured as DL or Flexible by higher-layer parameters and is used for uplink in part of RBs.

In one embodiment, the higher-layer parameter is carried by an RRC IE.

In one embodiment, a name of an RRC IE carrying the higher-layer parameter comprises TDD-UL-DL-Configure.

In one embodiment, the higher-layer parameter is carried by a TDD-UL-DL-ConfigCommon IE.

In one embodiment, the higher-layer parameter is a TDD-UL-DL-ConfigCommon IE.

In one embodiment, the first-type symbol comprises a symbol used for full duplex/SBFD.

In one embodiment, the first-type symbol is used for full duplex/SBFD.

In one embodiment, the first information block set configures the first-type symbol as first type.

In one embodiment, the first type is different from uplink and downlink.

In one embodiment, the first type is different from uplink, downlink and flexible.

In one embodiment, the first type is different from sidelink.

### Embodiment 12

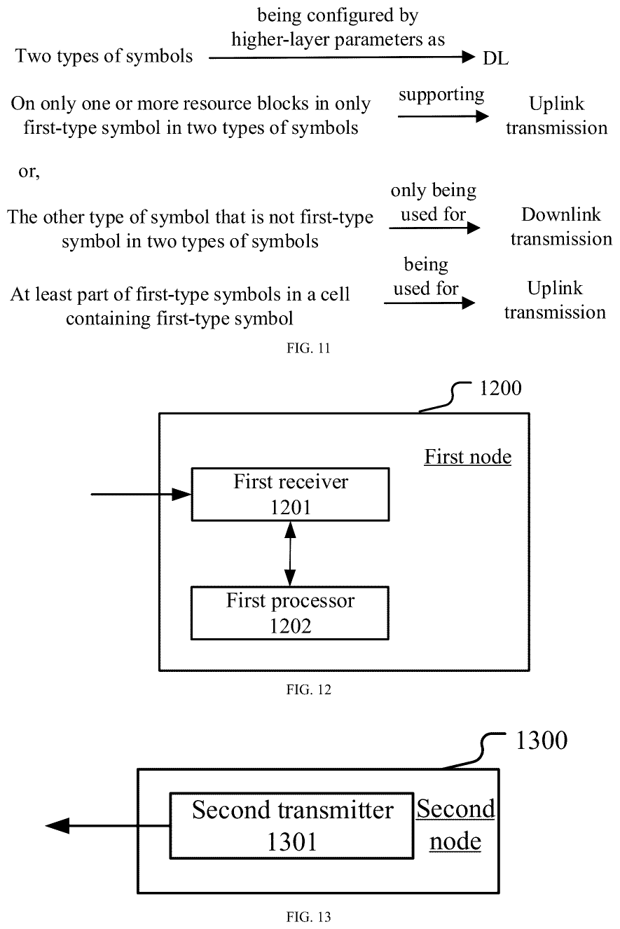

Embodiment 12 illustrates a structure block diagram of a processor in a first node according to one embodiment of the present application, as shown in FIG. 12. In FIG. 12, a processor 1200 in a first node comprises a first receiver 1201 and a first processor 1202.

In one embodiment, the first node is a UE.

In one embodiment, the first node is a relay node.

In one embodiment, the first receiver 1201 comprises at least one of the antenna 452, the receiver 454, the receiving processor 456, the multi-antenna receiving processor 458, the controller/processor 459, the memory 460, or the data source 467 in Embodiment 4.

In one embodiment, the first processor 1202 comprises at least one of the antenna 452, the receiver 454, the receiving processor 456, the multi-antenna receiving processor 458, the controller/processor 459, the memory 460, or the data source 467 in Embodiment 4.

In one embodiment, the first processor 1202 comprises at least one of the receiving processor 456, the multi-antenna receiving processor 458, the controller/processor 459, the memory 460, or the data source 467 in Embodiment 4.

The first receiver 1201 receives a first information block set, the first information block set is used to configure multiple CORESETs, the multiple CORESETs are configured to N cells, N being a positive integer greater than 1;
the first processor 1202 determines a first CORESET from the multiple CORESETs;
the first receiver 1201 monitors a PDCCH in only target CORESET group in the multiple CORESETs in a first time window;
in embodiment 12, the first time window consists of multiple overlapping PDCCH monitoring occasions, the multiple overlapping PDCCH monitoring occasions respectively comprise time-domain resources occupied by PDCCH candidates in the multiple CORESETs; the target CORESET group comprises each CORESET having same QCL properties as the first CORESET among the multiple CORESETs; each of the N cells comprises at least one of two types of symbols in the first time window; a determination of the first CORESET depends on whether at least one of the N cells comprises a first-type symbol in the first time window, and the first-type symbol is one of the two types of symbols.

In one embodiment, when there exists a cell comprising the first-type symbol in the first time window among the N cells, a determination of the first CORESET depends on cell(s) comprising the first-type symbol in the first time window among the N cells.

In one embodiment, when each of the N cells does not comprise the first-type symbol in the first time window, the first CORESET corresponds to a first CSS set, the first CSS set being a CSS set with lowest index in a cell with lowest index containing CSS sets, or the first CORESET corresponds to a first USS set, the first USS set being a USS set with lowest index in a cell with lowest index or the first USS set being a USS set with lowest index in a cell with lowest index containing USS sets.

In one embodiment, when there exists a cell comprising the first-type symbol in the first time window among the N cells, a first cell subgroup comprises cell(s) comprising the first-type symbol in the first time window among the N cells: the first CORESET corresponds to a second CSS set, the second CSS set being a CSS set in the first cell subgroup, or the first CORESET corresponds to a second USS set, the second USS set being a USS set in the first cell subgroup.

In one embodiment, when there exists a cell comprising the first-type symbol in the first time window among the N cells, the first CORESET corresponds to a first CSS set, the first CSS set being a CSS set with lowest index in a cell with lowest index containing CSS sets, or the first CORESET corresponds to a second USS set, the second USS set being a USS set in a first cell subgroup, and the first cell subgroup comprising cell(s) comprising the first-type symbol in the first time window among the N cells.

In one embodiment, comprising:
the first processor 1202 determines a second CORESET;
herein, the second CORESET is one of the multiple CORESETs, and QCL properties of the second CORESET are different from QCL properties of the first CORESET: the target CORESET group also comprises each CORESET having same QCL properties as the second CORESET among the multiple CORESETs.

In one embodiment, the two types of symbols are configured by higher-layer parameters as DL: uplink transmission is supported on one or more resource blocks (RBs) in only the first-type symbol of the two types of symbols, or the other type of symbol in the two types of symbols that is not the first-type symbol is only used for downlink transmission, and at least a part of first-type symbols in a cell comprising the first-type symbol is used for uplink transmission.

### Embodiment 13

Embodiment 13 illustrates a structure block diagram of a processor in a second node according to one embodiment of the present application, as shown in FIG. 13. In FIG. 13, a processor 1300 in a second node comprises a second transmitter 1301.

In one embodiment, the second node is a base station.

In one embodiment, the second node is a UE.

In one embodiment, the second node is a relay node.

In one embodiment, the second transmitter 1301 comprises at least one of the antenna 420, the transmitter 418, the transmitting processor 416, the multi-antenna transmitting processor 471, the controller/processor 475, or the memory 476 in Embodiment 4.

The second transmitter 1301 transmits a first information block set, the first information block set is used to configure multiple CORESETs, and the multiple CORESETs are configured to N cells, N being a positive integer greater than 1;

In embodiment 13, a receiver of the first information block set determines a first CORESET from the multiple CORESETs, and monitors a PDCCH in only a target CORESET group in the multiple CORESETs in a first time window: the first time window consists of multiple overlapping PDCCH monitoring occasions, the multiple overlapping PDCCH monitoring occasions respectively comprise time-domain resources occupied by PDCCH candidates in the multiple CORESETs: the target CORESET group comprises each CORESET having same QCL properties as the first CORESET among the multiple CORESETs: each of the N cells comprises at least one of two types of symbols in the first time window: a determination of the first CORESET depends on whether at least one of the N cells comprises a first-type symbol in the first time window, and the first-type symbol is one of the two types of symbols.

In one embodiment, when there exists a cell comprising the first-type symbol in the first time window among the N cells, a determination of the first CORESET depends on cell(s) comprising the first-type symbol in the first time window among the N cells.

In one embodiment, when each of the N cells does not comprise the first-type symbol in the first time window, the first CORESET corresponds to a first CSS set, the first CSS set being a CSS set with lowest index in a cell with lowest index containing CSS sets, or the first CORESET corresponds to a first USS set, the first USS set being a USS set with lowest index in a cell with lowest index or the first USS set being a USS set with lowest index in a cell with lowest index containing USS sets.

In one embodiment, when there exists a cell comprising the first-type symbol in the first time window among the N cells, a first cell subgroup comprises cell(s) comprising the first-type symbol in the first time window among the N cells: the first CORESET corresponds to a second CSS set, the second CSS set being a CSS set in the first cell subgroup, or the first CORESET corresponds to a second USS set, the second USS set being a USS set in the first cell subgroup.

In one embodiment, when there exists a cell comprising the first-type symbol in the first time window among the N cells, the first CORESET corresponds to a first CSS set, the first CSS set being a CSS set with lowest index in a cell with lowest index containing CSS sets, or the first CORESET corresponds to a second USS set, the second USS set being a USS set in a first cell subgroup, and the first cell subgroup comprising cell(s) comprising the first-type symbol in the first time window among the N cells.

In one embodiment, a receiver of the first information block set determines a second CORESET: the second CORESET is one of the multiple CORESETs, and QCL properties of the second CORESET are different from QCL properties of the first CORESET: the target CORESET group also comprises each CORESET having same QCL properties as the second CORESET among the multiple CORESETs.

In one embodiment, the two types of symbols are configured by higher-layer parameters as DL: uplink transmission is supported on one or more resource blocks (RBs) in only the first-type symbol of the two types of symbols, or the other type of symbol in the two types of symbols that is not the first-type symbol is only used for downlink transmission, and at least a part of first-type symbols in a cell comprising the first-type symbol is used for uplink transmission.

The ordinary skill in the art may understand that all or part of steps in the above method may be implemented by instructing related hardware through a program. The program may be stored in a computer readable storage medium, for example Read-Only Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. The user equipment, terminal and UE include but are not limited to Unmanned Aerial Vehicles (UAVs), communication modules on UAVs, telecontrolled aircrafts, aircrafts, diminutive airplanes, mobile phones, tablet computers, notebooks, vehicle-mounted communication equipment, wireless sensors, network cards, Internet of Things (IoT) terminals, RFID terminals, NB-IoT terminals, Machine Type Communication (MTC) terminals, enhanced MTC (eMTC) terminals, data card, network cards, vehicle-mounted communication equipment, low-cost mobile phones, low-cost tablets and other wireless communication devices. The UE and terminal in the present application include but not limited to unmanned aerial vehicles, communication modules on unmanned aerial vehicles, telecontrolled aircrafts, aircrafts, diminutive airplanes, mobile phones, tablet computers, notebooks, vehicle-mounted communication equipment, wireless sensor, network cards, terminals for Internet of Things, RFID terminals, NB-IoT terminals, Machine Type Communication (MTC) terminals, enhanced MTC (eMTC) terminals, data cards, low-cost mobile phones, low-cost tablet computers, etc. The base station or system device in the present application includes but is not limited to macro-cellular base stations, micro-cellular base stations, home base stations, relay base station, gNB (NR node B), Transmitter Receiver Point (TRP), and other radio communication equipment.

The above are merely the preferred embodiments of the present application and are not intended to limit the scope of protection of the present application. Any changes and modifications made based on the embodiments described in the specification, if similar partial or complete technical effects can be achieved, shall be deemed obvious and fall within the scope of protection of the present invention.

What is claimed is:

1. A first node for wireless communications, comprising:
a first receiver, receiving a first information block set, the first information block set being used to configure multiple CORESETs, the multiple CORESETs being configured to N cells, N being a positive integer greater than 1;
a first processor, determining a first CORESET from the multiple CORESETs; and
the first receiver, monitoring a PDCCH in only a target CORESET group in the multiple CORESETs in a first time window, the first time window consisting of multiple overlapping PDCCH monitoring occasions, the multiple overlapping PDCCH monitoring occasions respectively comprising time-domain resources occupied by PDCCH candidates in the multiple CORESETs;
wherein the target CORESET group comprises each CORESET having same QCL properties as the first CORESET among the multiple CORESETs; each of the N cells comprises at least one of two types of symbols in the first time window: a determination of the first CORESET depends on whether at least one of the N cells comprises a first-type symbol in the first time window, and the first-type symbol is one of the two types of symbols.

2. The first node according to claim 1, wherein
when there exists a cell comprising the first-type symbol in the first time window among the N cells, a determination of the first CORESET depends on cell(s) comprising the first-type symbol in the first time window among the N cells; or,
when there exists a cell comprising the first-type symbol in the first time window among the N cells, a first cell subgroup comprises cell(s) comprising the first-type symbol in the first time window among the N cells; the first CORESET corresponds to a second CSS set, the second CSS set being a CSS set in the first cell subgroup, or the first CORESET corresponds to a second USS set, the second USS set being a USS set in the first cell subgroup; or,
when there exists a cell comprising the first-type symbol in the first time window among the N cells, the first CORESET corresponds to a first CSS set, the first CSS set being a CSS set with lowest index in a cell with lowest index containing CSS sets, or the first CORESET corresponds to a second USS set, the second USS set being a USS set in a first cell subgroup, and the first cell subgroup comprising cell(s) comprising the first-type symbol in the first time window among the N cells.

3. The first node according to claim 1, wherein when each of the N cells does not comprise the first-type symbol in the first time window, the first CORESET corresponds to a first CSS set, the first CSS set being a CSS set with lowest index in a cell with lowest index containing CSS sets, or the first CORESET corresponds to a first USS set, the first USS set being a USS set with lowest index in a cell with lowest index or the first USS set being a USS set with lowest index in a cell with lowest index containing USS sets.

4. The first node according to claim 1, comprising:
the first processor, determining a second CORESET;
wherein the second CORESET is one of the multiple CORESETs, and QCL properties of the second CORESET are different from QCL properties of the first CORESET: the target CORESET group also comprises each CORESET having same QCL properties as the second CORESET among the multiple CORESETs.

5. The first node according to claim 1, wherein the two types of symbols are configured as DL by higher-layer parameter(s): uplink transmission is supported on one or more resource blocks (RBs) in only the first-type symbol of the two types of symbols, or the other type of symbol in the two types of symbols that is not the first-type symbol is only used for downlink transmission, and at least a part of first-type symbols in a cell comprising the first-type symbol is used for uplink transmission.

6. A second node for wireless communications, comprising:
a second transmitter, transmitting a first information block set, the first information block set being used to configure multiple CORESETs, the multiple CORESETs being configured to N cells, N being a positive integer greater than 1;
wherein a receiver of the first information block set determines a first CORESET from the multiple CORESETs, and monitors a PDCCH in only a target CORESET group in the multiple CORESETs in a first time window: the first time window consists of multiple overlapping PDCCH monitoring occasions, the multiple overlapping PDCCH monitoring occasions respectively comprise time-domain resources occupied by PDCCH candidates in the multiple CORESETs: the target CORESET group comprises each CORESET having same QCL properties as the first CORESET among the multiple CORESETs: each of the N cells comprises at least one of two types of symbols in the first time window; a determination of the first CORESET depends on whether at least one of the N cells comprises a first-type symbol in the first time window, and the first-type symbol is one of the two types of symbols.

7. The second node according to claim 6, wherein
when there exists a cell comprising the first-type symbol in the first time window among the N cells, a determination of the first CORESET depends on cell(s) comprising the first-type symbol in the first time window among the N cells; or,
when there exists a cell comprising the first-type symbol in the first time window among the N cells, a first cell subgroup comprises cell(s) comprising the first-type symbol in the first time window among the N cells; the first CORESET corresponds to a second CSS set, the second CSS set being a CSS set in the first cell subgroup, or the first CORESET corresponds to a second USS set, the second USS set being a USS set in the first cell subgroup; or,
when there exists a cell comprising the first-type symbol in the first time window among the N cells, the first CORESET corresponds to a first CSS set, the first CSS set being a CSS set with lowest index in a cell with lowest index containing CSS sets, or the first CORESET corresponds to a second USS set, the second USS set being a USS set in a first cell subgroup, and the first cell subgroup comprising cell(s) comprising the first-type symbol in the first time window among the N cells.

8. The second node according to claim 6, wherein when each of the N cells does not comprise the first-type symbol in the first time window, the first CORESET corresponds to a first CSS set, the first CSS set being a CSS set with lowest index in a cell with lowest index containing CSS sets, or the first CORESET corresponds to a first USS set, the first USS set being a USS set with lowest index in a cell with lowest index or the first USS set being a USS set with lowest index in a cell with lowest index containing USS sets.

9. The second node according to claim 6, wherein a receiver of the first information block set determines a second CORESET: wherein the second CORESET is one of the multiple CORESETs, and QCL properties of the second CORESET are different from QCL properties of the first CORESET: the target CORESET group also comprises each CORESET having same QCL properties as the second CORESET among the multiple CORESETs.

10. The second node according to claim 6, wherein the two types of symbols are configured as DL by higher-layer parameter(s); uplink transmission is supported on one or more resource blocks (RBs) in only the first-type symbol of the two types of symbols, or the other type of symbol in the two types of symbols that is not the first-type symbol is only used for downlink transmission, and at least a part of first-type symbols in a cell comprising the first-type symbol is used for uplink transmission.

11. A method in a first node for wireless communications, comprising:
receiving a first information block set, the first information block set being used to configure multiple CORESETs, the multiple CORESETs being configured to N cells, N being a positive integer greater than 1;
determining a first CORESET from the multiple CORESETs; and
monitoring a PDCCH in only a target CORESET group in the multiple CORESETs in a first time window, the first time window consisting of multiple overlapping PDCCH monitoring occasions, the multiple overlapping PDCCH monitoring occasions respectively comprising time-domain resources occupied by PDCCH candidates in the multiple CORESETs;
wherein the target CORESET group comprises each CORESET having same QCL properties as the first CORESET among the multiple CORESETs; each of the N cells comprises at least one of two types of symbols in the first time window: a determination of the first CORESET depends on whether at least one of the N cells comprises a first-type symbol in the first time window, and the first-type symbol is one of the two types of symbols.

12. The method according to claim 11, comprising:
when there exists a cell comprising the first-type symbol in the first time window among the N cells, a determination of the first CORESET depends on cell(s) comprising the first-type symbol in the first time window among the N cells; or,
when there exists a cell comprising the first-type symbol in the first time window among the N cells, a first cell subgroup comprises cell(s) comprising the first-type symbol in the first time window among the N cells; the first CORESET corresponds to a second CSS set, the second CSS set being a CSS set in the first cell subgroup, or the first CORESET corresponds to a second USS set, the second USS set being a USS set in the first cell subgroup; or,
when there exists a cell comprising the first-type symbol in the first time window among the N cells, the first CORESET corresponds to a first CSS set, the first CSS set being a CSS set with lowest index in a cell with lowest index containing CSS sets, or the first CORESET corresponds to a second USS set, the second USS set being a USS set in a first cell subgroup, and the first cell subgroup comprising cell(s) comprising the first-type symbol in the first time window among the N cells.

13. The method according to claim 11, wherein when each of the N cells does not comprise the first-type symbol in the first time window, the first CORESET corresponds to a first CSS set, the first CSS set being a CSS set with lowest index in a cell with lowest index containing CSS sets, or the first CORESET corresponds to a first USS set, the first USS set being a USS set with lowest index in a cell with lowest index or the first USS set being a USS set with lowest index in a cell with lowest index containing USS sets.

14. The method according to claim 11, comprising:
determining a second CORESET;
wherein the second CORESET is one of the multiple CORESETs, and QCL properties of the second CORESET are different from QCL properties of the first CORESET: the target CORESET group also comprises each CORESET having same QCL properties as the second CORESET among the multiple CORESETs.

15. The method according to claim 11, wherein the two types of symbols are configured as DL by higher-layer parameter(s); uplink transmission is supported on one or more resource blocks (RBs) in only the first-type symbol of the two types of symbols, or the other type of symbol in the two types of symbols that is not the first-type symbol is only used for downlink transmission, and at least a part of first-type symbols in a cell comprising the first-type symbol is used for uplink transmission.

16. A method in a second node for wireless communications, comprising:
transmitting a first information block set, the first information block set being used to configure multiple CORESETs, the multiple CORESETs being configured to N cells, N being a positive integer greater than 1;
wherein a receiver of the first information block set determines a first CORESET from the multiple CORESETs, and monitors a PDCCH in only a target CORESET group in the multiple CORESETs in a first time window: the first time window consists of multiple overlapping PDCCH monitoring occasions, the multiple overlapping PDCCH monitoring occasions respectively comprise time-domain resources occupied by PDCCH candidates in the multiple CORESETs: the target CORESET group comprises each CORESET having same QCL properties as the first CORESET among the multiple CORESETs: each of the N cells comprises at least one of two types of symbols in the first time window: a determination of the first CORESET depends on whether at least one of the N cells comprises a first-type symbol in the first time window, and the first-type symbol is one of the two types of symbols.

17. The method according to claim 16, comprising:
when there exists a cell comprising the first-type symbol in the first time window among the N cells, a determination of the first CORESET depends on cell(s) comprising the first-type symbol in the first time window among the N cells; or,
when there exists a cell comprising the first-type symbol in the first time window among the N cells, a first cell subgroup comprises cell(s) comprising the first-type symbol in the first time window among the N cells; the first CORESET corresponds to a second CSS set, the second CSS set being a CSS set in the first cell subgroup, or the first CORESET corresponds to a second USS set, the second USS set being a USS set in the first cell subgroup; or,
when there exists a cell comprising the first-type symbol in the first time window among the N cells, the first CORESET corresponds to a first CSS set, the first CSS set being a CSS set with lowest index in a cell with lowest index containing CSS sets, or the first CORESET corresponds to a second USS set, the second USS set being a USS set in a first cell subgroup, and the first cell subgroup comprising cell(s) comprising the first-type symbol in the first time window among the N cells.

18. The method according to claim 16, wherein when each of the N cells does not comprise the first-type symbol in the first time window, the first CORESET corresponds to a first CSS set, the first CSS set being a CSS set with lowest index in a cell with lowest index containing CSS sets, or the first CORESET corresponds to a first USS set, the first USS set being a USS set with lowest index in a cell with lowest index or the first USS set being a USS set with lowest index in a cell with lowest index containing USS sets.

19. The method according to claim 16, wherein a receiver of the first information block set determines a second CORESET: wherein the second CORESET is one of the multiple CORESETs, and QCL properties of the second CORESET are different from QCL properties of the first CORESET; the target CORESET group also comprises each CORESET having same QCL properties as the second CORESET among the multiple CORESETs.

20. The method according to claim 16, wherein the two types of symbols are configured as DL by higher-layer parameter(s): uplink transmission is supported on one or more resource blocks (RBs) in only the first-type symbol of the two types of symbols, or the other type of symbol in the two types of symbols that is not the first-type symbol is only used for downlink transmission, and at least a part of first-type symbols in a cell comprising the first-type symbol is used for uplink transmission.
